(19) United States
(12) Patent Application Publication
(10) Pub. No.: US 2010/0203324 A1
(43) Pub. Date: Aug. 12, 2010

(54) LAMINATE OF HEAT RESISTANT FILM AND METAL FOIL, AND METHOD FOR PRODUCTION THEREOF

(75) Inventor: Nobu Iizumi, Ube-shi (JP)

Correspondence Address: KNOBBE MARTENS OLSON & BEAR LLP, 2040 MAIN STREET, FOURTEENTH FLOOR, IRVINE, CA, 92614, US

(73) Assignee: UBE INDUSTRIES, LTD., Ube-shi, Yamaguchi (JP)

(21) Appl. No.: 12/375,282

(22) PCT Filed: Jul. 27, 2007
(86) PCT No.: PCT/JP2007/064822

§ 371 Date: Mar. 15, 2010

(30) Foreign Application Priority Data
Jul. 27, 2006 (JP) 2006-204546
Jul. 27, 2006 (JP) 2006-204547

(51) Int. Cl. B32B 15/088; C09J 179/08; C08G 73/10; C08F 299/02; C09J 5/00

(52) U.S. Cl. 428/336; 428/458; 156/307.5

(57) ABSTRACT

A laminate of the present invention is a laminate having a metal foil on one side or both sides of a heat resistant film in which the metal foil is laminated on the heat resistant film via a cured layer of a terminal-modified oligomer obtained by reacting simultaneously or successively a tetracarboxylic dianhydride and a diamine in a molar ratio of n:(n+1) (n is a number of 2 to 6) and a carboxylic acid compound having an unsaturated group, which is formed by heating and reacting the terminal-modified oligomer. The laminate of a heat resistant film and a metal foil may be easily produced. Moreover, the laminate may have excellent adhesive properties and excellent heat resistance, and withstand a soldering process or a high temperature process for mounting a chip on a substrate.

### TECHNICAL FIELD

The present invention relates to a laminate of a heat resistant film and a metal foil, which has excellent adhesiveness (adhesive strength) and heat resistance.

The present invention also relates to a laminate of a heat resistant film and a metal foil with low roughness such as a copper foil with low roughness, which has excellent adhesion between the heat resistant film and the metal foil, and heat resistance.

Furthermore, the present invention also relates to a process for producing a laminate of a heat resistant film and a metal foil, which has excellent adhesiveness (adhesive strength) and heat resistance, with high productivity.

### BACKGROUND ART

A heat resistant film such as an aromatic polyimide film having a metal wiring formed thereon is used as COF (Chip On Film, Chip On Flex) and FPC (Flexible Printed Circuit Board) in the field of electronic devices such as a camera, a personal computer and a liquid crystal display.

There have been reported methods for producing a laminate by laminating a metal foil on an aromatic polyimide film via a thermosetting compound or polymer, and metal foil-laminated polyimide films produced by the methods.

Patent document 1 discloses a cross-linkable group-containing polyimide precursor or polyimide which has cross-linkable groups at 5 mol % to 99 mol % of the polyimide molecular terminals; more specifically, a cross-linkable group-containing polyimide precursor or polyimide obtained by the polycondensation reaction of a diamine, a tetracarboxylic dianhydride, and a cross-linkable group-containing dicarboxylic anhydride such as maleic anhydride; and a laminate having a copper foil bonded onto a cross-linked polyimide which is prepared by heating the cross-linkable group-containing polyimide precursor or polyimide.

Patent document 2 discloses a metal laminate produced by laminating a resin composition, which is obtained by adding a specific bismaleimide compound to a polyamic acid and/or a polyimide, on at least one side of a metal foil; more preferably, a metal laminate having a metal laminated on a polyimide layer, which is the above-mentioned resin composition comprising a specific bismaleimide compound, formed on one side or both sides of a non-thermoplastic polyimide film.

Patent document 3 discloses a laminate produced by laminating a copper foil on a polyimide film with a terminal-modified imide oligomer which is obtained by the reaction of an aromatic tetracarboxylic acid component, a diamine component, and a dicarboxylic acid component having an unsaturated group; more specifically, a terminal-modified imide oligomer obtained by the reaction of 2,3,3′,4′-biphenyltetracarboxylic dianhydride, 1,3-bis(4-aminophenoxy)benzene, and maleic anhydride. It is described in Patent document 3 that the thickness of the adhesive layer composed of the terminal-modified imide oligomer is 20 μm, and the terminal-modified imide oligomer is reacted at 200° C. for 6 hours; therefore the laminate obtained is not practical because many cracks occur in the adhesive layer of the terminal-modified imide oligomer when the laminate is bent.

Patent document 1: Japanese Laid-open Patent Publication No. 2001-323062;

Patent document 2: Japanese Laid-open Patent Publication No. 2004-209962;

Patent document 3: Japanese Laid-open Patent Publication No. H02-274762.

### DISCLOSURE OF THE INVENTION

### Problems to be Solved by the Invention

A laminate of a polyimide film and a metal foil, which is used for COF and FPC in the field of electronic materials, needs to have high heat resistance and withstand high temperature processes for soldering float or for gold-tin eutexia in a mounting process. Furthermore, there is the need for a laminate of a polyimide film and a metal foil with low roughness having excellent adhesion between the polyimide film and the metal foil, which allow the formation of a fine-pitch wiring.

Conventionally, a laminate of a polyimide film and a metal foil, which is used for COF, is produced by forming a metal layer directly on a heat-resistant non-thermoplastic polyimide film by sputtering. However, the laminate produced by directly forming the metal layer on the polyimide film by sputtering is liable to have insufficient reliability of adhesion between the metal and the polyimide film, and it may have pinholes formed during sputtering. There is the need for a laminate of a heat resistant film and a metal foil such as a laminate of a polyimide film and a metal foil which is phihole-free and has high reliability of adhesion between the metal and the heat resistant film.

An objective of the present invention is to provide a laminate of a heat resistant film and a metal foil such as a laminate of a polyimide film and a metal foil which is easily produced, and has so excellent adhesive properties and so excellent heat resistance that it can withstand a soldering process or a high temperature process for mounting a chip thereon.

Another objective of the present invention is to provide a process for producing a laminate of a heat resistant film and a metal foil as described above with high productivity.

### Means for Solving the Problems

The present invention relates to the following matters:

[1] A laminate having a metal foil on one side or both sides of a heat resistant film, wherein

the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group;

the diamine component comprises a diamine represented by the general formula (1):

H₂N—Y—NH₂ (1)

wherein
Y represents a divalent group selected from the groups listed as the following formula (2):

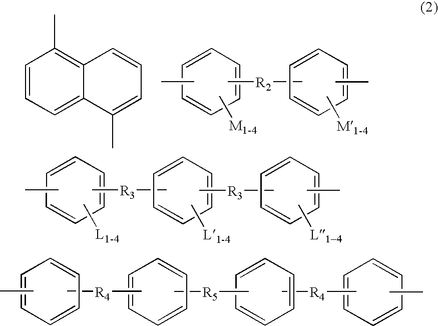

wherein
R₂, R₃, R₄ and R₅ independently represent a single bond, or a divalent group selected from the group consisting of —O—, —S—, —CO—, —SO₂—, —CH₂—, —C(CH₃)₂—, and —C(CF₃)₂—,
M₁-M₄, M′₁-M′₄, L₁-L₄, L′₁-L′₄ and L″₁-L″₄ independently represent —H, —F, —Cl, —Br, —I, —CN, —OCH₃, —OH, —COOH, —CH₃, —C₂H₅, or —CF₃,
R₂, R₃, R₄ and R₅ may be the same as, or different from each other, and
M₁-M₄, M′₁-M′₄, L₁-L₄, L′₁-L′₄ and L″₁-L″₄ may be the same as, or different from each other,
as a main component;

the tetracarboxylic dianhydride component comprises a tetracarboxylic dianhydride represented by the general formula (3):

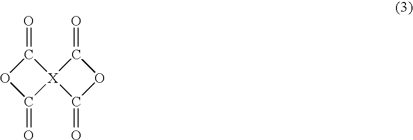

wherein

X represents a tetravalent group selected from the groups listed as the following formula (4):

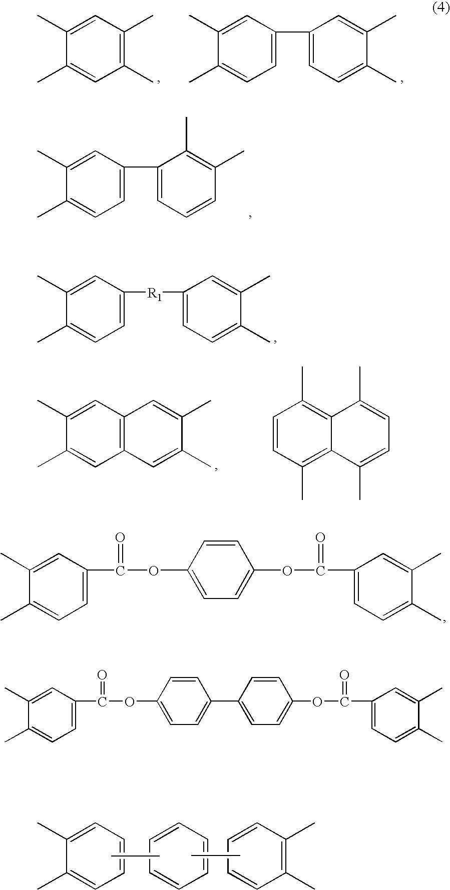

wherein
R₁ represents a divalent group selected from the groups listed as the following formula (5):

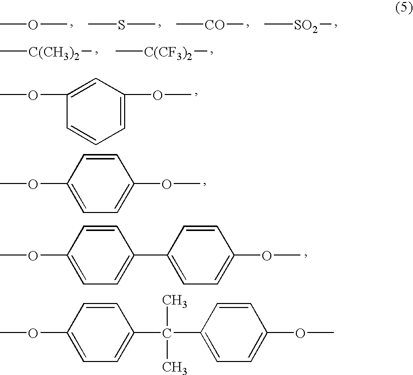

as a main component; and

the carboxylic acid compound is represented by the general formula (6):

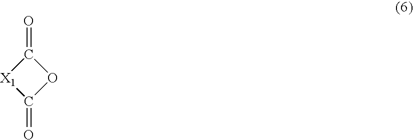

wherein
X₁ represents a divalent group selected from the groups listed as the following formula (7):

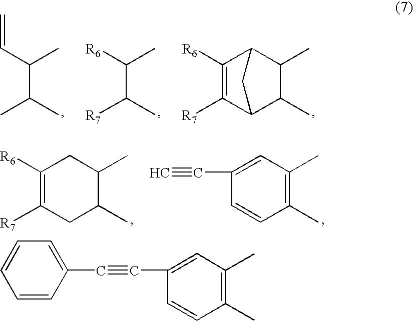

wherein
R₆ and R₇ independently represent —H, —F, —CH₃, —C₂H₅, —CF₃, or -phenyl, and
R₆ and R₇ may be the same as, or different from each other.

[2] The laminate of a heat resistant film and a metal foil as described in [1], wherein

the diamine component is a diamine represented by the general formula (1′):

H₂N—Y—NH₂ (1′)

wherein
Y represents a divalent group selected from the groups listed as the following formula (2′):

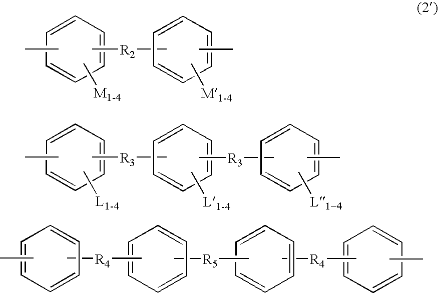

wherein
R₂ represents a single bond, or a divalent group selected from the group consisting of —O—, —S—, —CH₂—, and —C(CH₃)₂—,
R₃ and R₄ independently represent —O—, or —S—,
R₅ represents a single bond, or a divalent group selected from the group consisting of —O—, —CH₂—, and —C(CH₃)₂—,
M₁—M₄, M′₁-M′₄, L₁-L₄, L′₁-L′₄ and L″₁-L″4 independently represent —H, or —CH₃,
R₂, R₃, R₄ and R₅ may be the same as, or different from each other, and
M₁-M₄, M′₁-M′₄, L₁-L₄, L′₁-L′₄ and L″₁-L″₄ may be the same as, or different from each other;

the tetracarboxylic dianhydride component is a tetracarboxylic dianhydride represented by the general formula (3′):

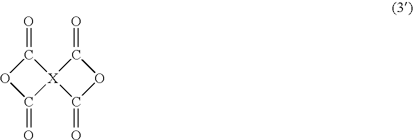

wherein
X represents a tetravalent group selected from the groups listed as the following formula (4′):

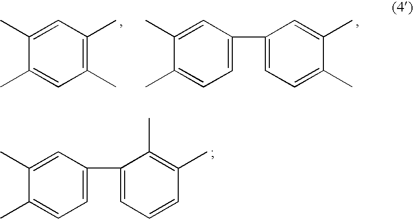

and

the carboxylic acid compound having an unsaturated group is a compound represented by the general formula (6′):

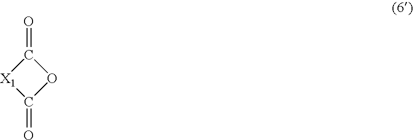

wherein
X₁ represents a divalent group selected from the groups listed as the following formula (7′):

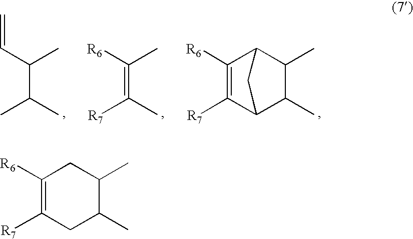

wherein
R₆ and R₇ independently represent —H, —F, —CH₃, —C₂H₅, —CF₃, or -phenyl, and
R₆ and R₇ may be the same as, or different from each other.

[3] The laminate of a heat resistant film and a metal foil as described in any one of [1] to [2], wherein the cured layer of the terminal-modified oligomer is a cured layer of a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 3, preferably 1 to 2).

[4] The laminate of a heat resistant film and a metal foil as described in any one of [1] to [3], wherein the terminal-modified oligomer is

1) a terminal-modified oligomer obtained by reacting a oligomer which is obtained by reacting a tetracarboxylic dianhydride component and a diamine component with a carboxylic acid compound having an unsaturated group which is represented by the general formula (6); or

2) a terminal-modified oligomer obtained by reacting simultaneously a tetracarboxylic dianhydride component, a diamine component, and a carboxylic acid compound having an unsaturated group which is represented by the general formula (6).

[5] The laminate of a heat resistant film and a metal foil as described in any one of [1] to [4], wherein the carboxylic acid compound having an unsaturated group which is represented by the general formula (6) is maleic anhydride.

[6] The laminate of a heat resistant film and a metal foil as described in any one of [1] to [5], wherein the cured layer of the terminal-modified oligomer is obtained by heating a terminal-modified oligomer to a temperature lower by 10° C. than the curing initiation temperature of the terminal-modified oligomer, or higher.

[7] The laminate of a heat resistant film and a metal foil as described in any one of [1] to [6], wherein the cured layer of the terminal-modified oligomer has a thickness of 0.5 μm to 12 μm.

[8] The laminate of a heat resistant film and a metal foil as described in any one of [1] to [7], wherein the heat resistant film is a heat resistant polyimide film.

[9] The laminate of a heat resistant film and a metal foil as described in any one of [1] to [8], wherein the cured layer of the terminal-modified oligomer is obtained by heating a terminal-modified oligomer composition which comprises a terminal-modified oligomer and 0.1 wt % to 10 wt % of a radical generator based on the solid content of the terminal-modified oligomer to react it.

[10] A process for producing a laminate having a metal foil on one side or both sides of a heat resistant film wherein the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group which is represented by the above general formula (6); comprising:

(1) a step of forming a terminal-modified oligomer layer on a heat resistant film and/or a metal foil by

applying a solution of a terminal-modified oligomer in an organic solvent to one side or both sides of a heat resistant film or one side of a metal foil;

removing the organic solvent contained in the solution applied to the heat resistant film or the metal foil; and

heating the heat resistant film or the metal foil having the terminal-modified oligomer thereon to effect imidization, if the terminal-modified oligomer comprises a polyimide precursor;

(a1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon; and

pressing the laminate at a temperature lower by 10° C. than the softening temperature of the terminal-modified oligomer, or higher; and

(a2) a step of heating the pressed laminate of the heat resistant film, the terminal-modified oligomer layer and the metal foil up to a temperature lower by 10° C. than the curing initiation temperature of the terminal-modified oligomer, or higher to cure the terminal-modified oligomer.

[11] A process for producing a laminate having a metal foil on one side or both sides of a heat resistant film wherein the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group which is represented by the above general formula (6); comprising:

(1) a step of forming a terminal-modified oligomer layer on a heat resistant film and/or a metal foil by

applying a solution of a terminal-modified oligomer in an organic solvent to one side or both sides of a heat resistant film or one side of a metal foil;

removing the organic solvent contained in the solution applied to the heat resistant film or the metal foil; and

heating the heat resistant film or the metal foil having the terminal-modified oligomer thereon to effect imidization, if the terminal-modified oligomer comprises a polyimide precursor; and

(b1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon; and

heating and pressing the laminate at a temperature lower by 10° C. than the curing initiation temperature of the terminal-modified oligomer, or higher to cure the terminal-modified oligomer.

[12] The process for producing a laminate of a heat resistant film and a metal foil as described in any one of [10] to [11], wherein the solution of the terminal-modified oligomer in the organic solvent contains 0.1 wt % to 10 wt % of a radical generator capable of generating oxygen radicals or carbon radicals based on the solid content of the terminal-modified oligomer.

[13] The process for producing a laminate of a heat resistant film and a metal foil as described in any one of [10] to [12], wherein the terminal-modified oligomer is a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 3, preferably 1 to 2).

The “oligomer” used in the present invention is an oligomer obtained by reacting a tetracarboxylic dianhydride component and a diamine component in a molar ratio of n:(n+1) (n is a number of 2 to 6) and includes an imide precursor (amic acid) oligomer, an imide oligomer, an oligomer having both an imide precursor structure and an imide structure, and mixtures thereof.

The “terminal-modified oligomer” used in the present invention is an oligomer obtained by reacting the above-mentioned oligomer and a carboxylic acid compound having an unsaturated group, or an oligomer obtained by reacting simultaneously or successively a tetracarboxylic dianhydride component, a diamine component and a carboxylic acid compound having an unsaturated group in an organic solvent, for example, and includes a terminal-modified imide precursor (amic acid) oligomer, a terminal-modified imide oligomer, a terminal-modified oligomer having both an imide precursor structure and an imide structure, and mixtures thereof, with the proviso that the molar ratio of the tetracarboxylic dianhydride component to the diamine component is n:(n+1) (n is a number of 2 to 6).

### EFFECT OF THE INVENTION

The laminate of a heat resistant film and a metal foil of the present invention is produced by laminating a metal foil such as a copper foil on a heat resistant film via a cured layer of a terminal-modified oligomer, which is obtained by reacting simultaneously or successively a tetracarboxylic dianhydride component, a diamine component, and a carboxylic acid compound having an unsaturated group and represented by the above general formula (6). The cured layer of the terminal-modified oligomer is prepared by the addition reaction and/or cross-linking reaction for polymerization of a terminal-modified oligomer in which an imide oligomer and/or an imide precursor oligomer is modified with a carboxylic acid compound having an unsaturated group at its amino terminal; for example, by heating the terminal-modified oligomer at a temperature of around the curing initiation temperature of the terminal-modified oligomer, or higher. The laminate of a heat resistant film and a metal foil of the present invention may be easily produced, and have excellent heat resistance and adhesive properties. It may be used as a material for an electronic component or an electronic device such as a printed wiring board, a flexible printed circuit board, COF, COB and TAB tapes.

According to the present invention, the terminal-modified oligomer to be used does not contain a high-molecular-weight polyimide as claimed in claim 1 of JP-A-H02-274762 (JP-B-2597181) as a main component, and therefore a metal foil may be laminated on a heat resistant film with ease, and the laminate obtained may have excellent adhesive properties and heat resistance.

Furthermore, in the present invention, the cured layer of the terminal-modified oligomer may preferably have a thickness of 0.5 μm to 12 μm. When the cured layer of the terminal-modified oligomer is too thick, due to the decrease in heat resistance, the laminate may not withstand a high temperature process for mounting a chip thereon, and a metal wiring may be buried into the polyimide layer of the laminate.

In addition, according to the present invention, the use of an oligomer allows the easy removal of the solvent after applying the solution to a base material. Specifically, after applying an oligomer solution to a base material such as a metal foil and a heat resistant film, the solvent may be removed more readily than a polymer solution. Consequently, little foaming may be caused by the residual solvent during thermocompression bonding, and the laminate may be produced with high quality stability and high productivity. A metal foil may be laminated on a heat resistant film at a lower temperature when using an oligomer than when using a polyamic acid and/or a polyimide which have compositions corresponding to the oligomer.

According to the present invention, a metal foil such as a copper foil is laminated on a heat resistant film such as a polyimide film via a cured product (thermal reaction product) of a terminal-modified imide oligomer having a polymerization degree of 2 to 6 and/or a terminal-modified imide precursor oligomer having a polymerization degree of 2 to 6. Generally, the terminal-modified oligomer must be heated at a temperature higher than the curing initiation temperature to react it until the cured oligomer has sufficiently high adhesiveness. In a step of heating and reacting the terminal-modified oligomer until the cured oligomer has sufficiently high adhesiveness, the heating temperature may be high, and the high heating temperature and the long heating time lead to the higher cost. From the viewpoint of the productivity, it is desirable to react the terminal-modified oligomer at a lower temperature for a shorter time.

In the process for producing a laminate of a heat resistant film and a metal foil of the present invention, a radical generator may be preferably added in an amount of 0.1 wt % to 10 wt % based on the solid content of the terminal-modified oligomer so as to accelerate the reaction of the terminal-modified oligomer. When using a radical generator, a cured oligomer having sufficiently high adhesiveness may be obtained by reacting a terminal-modified oligomer at a lower temperature for a shorter time, resulting in improvements in productivity.

### BEST MODE FOR CARRYING OUT THE INVENTION

The laminate of a heat resistant film and a metal foil of the present invention has a metal foil laminated on one side or both sides of a heat resistant film via a cured layer of a terminal-modified oligomer as described above. The cured layer of the terminal-modified oligomer in the laminate may be preferably obtained by heating a terminal-modified oligomer to a temperature lower by 10° C. than the curing initiation temperature of the terminal-modified oligomer, or higher, more preferably to a temperature lower by 5° C. than the curing initiation temperature of the terminal-modified oligomer, or higher. In the present invention, a terminal-modified oligomer may be particularly preferably polymerized and/or cross-linked

(1) by pressing a laminate of a heat resistant film, a terminal-modified oligomer layer and a metal foil, which are laminated in this order, at a temperature equal to or higher than the temperature lower by 10° C. than the softening temperature of the terminal-modified oligomer, preferably at a temperature equal to or higher than the temperature lower by 5° C. than the softening temperature of the terminal-modified oligomer, more preferably at a temperature equal to or higher than the softening temperature of the terminal-modified oligomer, further preferably at a temperature equal to or higher than the temperature higher by 5° C. than the softening temperature of the terminal-modified oligomer, particularly preferably at a temperature equal to or higher than the temperature higher by 10° C. than the softening temperature of the terminal-modified oligomer (temporary thermocompression bonding); and then

heating the laminate at a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer; or alternatively,

(2) by heating and pressing a laminate of a heat resistant film, a terminal-modified oligomer layer and a metal foil, which are laminated in this order, at a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer.

The heat resistant film to be used may be a film which is used as a material for an electronic component such as a printed wiring board, a flexible printed circuit board, COF and TAB tapes. Any film which is not plasticized at a heating temperature for curing a terminal-modified oligomer may be used without limitation. The heat resistant film to be used may be a cross-linked product or a composite comprising a fiber.

Examples of the heat resistant film may include heat resistant films such as a polyimide film, a polyamide-imide film, a thermosetting polyimide film, an aromatic polyamide film, a polysulfone film, a polyether-sulfone film, a polyketone film, a polyether-ketone film, and a liquid-crystal resin film; and composite films thereof with a heat resistant fiber such as a carbon fiber, a polyimide fiber, a polyamide fiber, and a glass fiber.

The laminate of a heat resistant film and a metal foil of the present invention may preferably comprise a heat resistant polyimide film as a heat resistant film.

When using a heat resistant polyimide film as a heat resistant film, the heat resistant film may be a polyimide prepared from an acid component (3,3′,4,4′-biphenyltetracarboxylic dianhydride, pyromellitic acid, and the like) and a diamine component (p-phenylenediamine, 4,4′-diaminodiphenyl ether, m-tolidine, 4,4′-diaminobenzanilide, and the like) or a polyimide comprising an acid component and a diamine component which constitute a heat resistant film, for example.

Specific examples of the heat resistant polyimide film include heat resistant films such as “Kapton” (trade name) made by Du Pont-Toray Co., Ltd., or E.I. du Pont de Nemours & Company; “Apical” (trade name) made by KANEKA CORPORATION; and “UPILEX” (trade name) made by UBE INDUSTRIES, LTD.; and polyimide films prepared from, or comprising an acid component and a diamine component which constitute at least one of these heat resistant films.

The thickness of the heat resistant film may be appropriately selected depending on an intended application. It may be preferably from 5 μm to 150 μm, more preferably from 8 μm to 120 μm, further preferably from 10 μm to 80 μm, particularly preferably from 15 μm to 40 μm, for a practical use.

While the heat resistant film may be used without any treatment, the surface of the heat resistant film which is to be in contact with the terminal-modified oligomer or the cured product thereof may be preferably subjected to surface treatment with a surface treatment agent, and/or surface treatment such as discharge treatment, including corona discharge treatment, low-temperature plasma discharge treatment, and atmospheric plasma discharge treatment, and chemical etching, if necessary, before use for improving adhesive properties and/or coating properties.

When using a heat resistant polyimide film prepared from an tetracarboxylic acid component comprising 3,3′,4,4′-biphenyltetracarboxylic dianhydride as a main component and a diamine component comprising p-phenylenediamine as a main component, in particular, the surface of the heat resistant film which is to be in contact with the terminal-modified oligomer or the cured product thereof may be preferably subjected to surface treatment with a surface treatment agent, and/or surface treatment such as discharge treatment, including corona discharge treatment, low-temperature plasma discharge treatment, and atmospheric plasma discharge treatment, and chemical etching before use so as to improve adhesive properties and/or coating properties.

Any known surface treatment agent may be used in the present invention. Examples of the surface treatment agent include aminosilane-based surface treatment agents, epoxysilane-based surface treatment agents, and titanate-based surface treatment agents. Examples of the aminosilane-based surface treatment agent include γ-aminopropyl triethoxy silane, N-β-(aminoethyl)-γ-aminopropyl triethoxy silane, N-(aminocarbonyl-γ-aminopropyl triethoxy silane, N-[β-(phenylamino)-ethyl]-γ-aminopropyl triethoxy silane, N-phenyl-γ-aminopropyl triethoxy silane, and N-phenyl-aminopropyl trimethoxy silane. Examples of the epoxysilane-based surface treatment agent include β-(3,4-epoxycyclohexyl)ethyl trimethoxy silane, and γ-glycidoxypropyl trimethoxy silane. Examples of the titanate-based surface treatment agent include isopropyl tricumyl phenyl titanate, and dicumyl phenyl oxyacetate titanate.

The surface treatment may be conducted by dissolving or dispersing a surface treatment agent in a solvent; applying the resulting solution to a metal foil and/or a heat resistant film by any known method such as coating, spraying and dipping; and then removing the solvent.

The metal foil to be used may be made of either a single metal or an alloy. Specific examples of the metal foil include a copper foil, an aluminum foil, a gold foil, a silver foil, a nickel foil and a stainless steel foil. A heat resistant film having a metal-plated layer thereon (various known techniques may be employed, and a metal vapor deposited underlayer/a metal plated layer or a metal chemical plated layer may be suitably employed.) may be also used. A copper foil such as a rolled copper foil and an electrolytic copper foil may be suitably used.

Although there are no particular restrictions to the surface roughness of the metal foil to be used, the surface roughness (Rz) of the metal foil may be preferably 0.5 μm or more. In addition, the surface roughness (Rz) of the metal foil may be preferably 7 μm or less, particularly preferably 5 μm or less. Such a metal foil, particularly a copper foil, is known, for example, VLP and LP (or HTE).

Although there are no particular restrictions to the thickness of the metal foil to be used, as long as it may be practically or productively employed, it may be preferably from 0.01 μm to 10 mm, more preferably from 0.05 μm to 500 μm, further preferably from 0.1 μm to 100 μm, particularly preferably from 0.5 μm to 50 μm.

The metal foil to be used may be a metal foil with a carrier such as a copper foil with an aluminum foil carrier, and a copper foil with a copper foil carrier.

A metal foil which is used for a wiring circuit may be particularly preferably used.

For the purpose of improving adhesive properties of the metal foil, the surface of the metal foil may be subjected to chemical or mechanical surface treatment such as siding, nickel plating, copper-zinc alloy plating, and surface treatment with an aluminum alcoholate, an aluminum chelate, a silane coupling agent, triazine thiol, benzotriazole, acetylene alcohol, acetylacetone, catechol, o-benzoquinone, tannin, quinolinol, and the like.

The terminal-modified oligomer used in the present invention may be obtained by reacting simultaneously or successively a tetracarboxylic dianhydride component (comprising a tetracarboxylic dianhydride represented by the general formula (3) as a main component) and a diamine component (comprising a diamine represented by the general formula (1) as a main component) in a molar ratio of n:(n+1) (n is a number of 2 to 6) and a carboxylic acid compound having an unsaturated group which is represented by the general formula (6). The terminal-modified oligomer may be, for example,

1) a terminal-modified imide oligomer obtained by reacting an imide oligomer, which is obtained by reacting a tetracarboxylic dianhydride component (comprising a tetracarboxylic dianhydride represented by the general formula (3) as a main component) and a diamine component (comprising a diamine represented by the general formula (1) as a main component) in a molar ratio of n:(n+1) (n is a number of 2 to 6), with a carboxylic acid compound having an unsaturated group which is represented by the general formula (6);

2) a terminal-modified imide precursor oligomer obtained by reacting an imide precursor oligomer, which is obtained by reacting a tetracarboxylic dianhydride component (comprising a tetracarboxylic dianhydride represented by the general formula (3) as a main component) and a diamine component (comprising a diamine represented by the general formula (1) as a main component) in a molar ratio of n:(n+1) (n is a number of 2 to 6), with a carboxylic acid compound having an unsaturated group which is represented by the general formula (6);

3) a terminal-modified imide oligomer obtained by imidizing the terminal-modified imide precursor oligomer which is prepared as described in 2), for example, by heating;

4) a terminal-modified imide precursor oligomer obtained by reacting simultaneously a tetracarboxylic dianhydride component (comprising a tetracarboxylic dianhydride represented by the general formula (3) as a main component) and a diamine component (comprising a diamine represented by the general formula (1) as a main component) in a molar ratio of n:(n+1) (n is a number of 2 to 6) and a carboxylic acid compound having an unsaturated group which is represented by the general formula (6);

5) a terminal-modified imide oligomer obtained by imidizing the terminal-modified imide precursor oligomer which is prepared as described in 4), for example, by heating; or

6) a terminal-modified imide oligomer obtained by reacting simultaneously a tetracarboxylic dianhydride component (comprising a tetracarboxylic dianhydride represented by the general formula (3) as a main component) and a diamine component (comprising a diamine represented by the general formula (1) as a main component) in a molar ratio of n:(n+1) (n is a number of 2 to 6) and a carboxylic acid compound having an unsaturated group which is represented by the general formula (6).

The terminal-modified oligomer may be preferably obtained by reacting simultaneously or successively a tetracarboxylic dianhydride component, a diamine component, and a carboxylic acid compound having an unsaturated group which is represented by the general formula (6) in a molar ratio of n:(n+1):m in which n is a number of 2 to 6, preferably 2 to 5, more preferably 2 to 4, particularly preferably 2 to 3, and m is a number of 1 to 3, preferably 1 to 2. The terminal-modified oligomer may be preferably obtained by reacting a tetracarboxylic dianhydride component, a diamine component, and a carboxylic acid compound having an unsaturated group which is represented by the general formula (6) in a molar ratio of n:(n+1):m in which the upper limit and lower limit of n may be appropriately selected from 2, 3, 4, 5 and 6, the lower limit of m may be appropriately selected from 1.0, 1.1, 1.2, 1.3, 1.4, 1.5, 1.6, 1.7, 1.8 and 1.9, and the upper limit of m may be appropriately selected from 3.0, 2.8, 2.5, 2.3, 2.2, 2.1 and 2.0.

The softening temperature and/or the curing initiation temperature of the terminal-modified oligomer tends to be lower as the value of n is smaller. Accordingly, thermocompression bonding may be conducted at a lower temperature when using a terminal-modified oligomer having a smaller n, and therefore such a terminal-modified oligomer may be preferably selected.

In cases where the terminal-modified oligomer is prepared, the terminal-modified oligomer may be preferably prepared by reacting simultaneously or successively a tetracarboxylic dianhydride component, a diamine component, and a carboxylic acid compound having an unsaturated group which is represented by the general formula (6) in a molar ratio of n:(n+1):m in which n is a number of 2 to 6, preferably 2 to 5, more preferably 2 to 4, particularly preferably 2 to 3, and m is a number of 1 to 3, preferably 1 to 2. The terminal-modified oligomer may be prepared by reacting a tetracarboxylic dianhydride component, a diamine component, and a carboxylic acid compound having an unsaturated group which is represented by the general formula (6) in a molar ratio of n:(n+1):m in which the upper limit and lower limit of n may be appropriately selected from 2, 3, 4, 5 and 6, the lower limit of m may be appropriately selected from 1.0, 1.1, 1.2, 1.3, 1.4, 1.5, 1.6, 1.7, 1.8 and 1.9, and the upper limit of m may be appropriately selected from 3.0, 2.8, 2.5, 2.3, 2.2, 2.1 and 2.0.

In the preparation of the terminal-modified oligomer, the molar ratio (m) of the carboxylic acid compound having an unsaturated group which is represented by the general formula (6) may be preferably from 1 to 2, although it may be more than 2.

For the terminal-modified imide oligomer, the composition of the oligomer (molecular-weight distribution, polymerization degree, for example), an acid component, a diamine component, a carboxylic acid compound having an unsaturated group which is represented by the general formula (6), and the like may be appropriately selected depending on properties required for an intended application, the laminating conditions (temporary thermocompression bonding conditions), and the heating conditions (reaction conditions of terminal modifying groups).

As compared to a terminal-modified polymer, a terminal-modified imide oligomer generally has a lower softening temperature, a lower curing initiation temperature, and more addition reactive sites, and may provide a cured product having a higher glass transition temperature and a higher melting viscosity at a temperature higher than the glass transition temperature after curing.

For the terminal-modified imide oligomer, the following may be preferably selected in view of the properties before and after heating conditions (reaction conditions of terminal modifying groups).

1) the kinds of a tetracarboxylic dianhydride component, a diamine component, and a carboxylic acid compound having an unsaturated group which is represented by the general formula (6);

2) the molar ratio of a tetracarboxylic dianhydride component and a diamine component [n:(n+1) (n is a number of 2 to 6, preferably 2 to 5, more preferably 2 to 4, particularly preferably 2 to 3.)]; and

3) the molar ratio of a tetracarboxylic dianhydride component, a diamine component and a carboxylic acid compound having an unsaturated group which is represented by the general formula (6) [n:(n+1):m (n is a number of 2 to 6, preferably 2 to 5, more preferably 2 to 4, particularly preferably 2 to 3, and m is a number of 1 to 3, preferably 1 to 2.)].

For the terminal-modified imide oligomer, the following may be preferably selected in view of the laminating conditions (temporary thermocompression bonding conditions), the heating conditions (reaction conditions of terminal modifying groups), and the melting viscosity of the cured product of the terminal-modified imide oligomer preferably at a temperature higher than the glass transition temperature.

1) the molar ratio of a tetracarboxylic dianhydride component and a diamine component [n:(n+1) (n is a number of 2 to 6, preferably 2 to 5, more preferably 2 to 4, particularly preferably 2 to 3.)]; and

2) the molar ratio of a tetracarboxylic dianhydride component, a diamine component and a carboxylic acid compound having an unsaturated group which is represented by the general formula (6) [n:(n+1):m (n is a number of 2 to 6, preferably 2 to 5, more preferably 2 to 4, particularly preferably 2 to 3, and m is a number of 1 to 3, preferably 1 to 2.)].

The terminal-modified imide oligomer may be used in combination with a polyimide precursor and/or a polyimide, as long as the characteristics of the present invention would not be impaired.

The thickness of the cured layer of the terminal-modified oligomer may be appropriately selected depending on an intended application. The cured layer of the terminal-modified oligomer may preferably have such a thickness that cracks may not occur in the laminate of a heat resistant film and a metal foil when the laminate is bent. Furthermore, the cured layer of the terminal-modified oligomer may preferably have such a thickness that very little solvent may remain in the cured layer or the laminate. It may be, for example, from 0.5 μm to 15 μm, preferably from 0.5 μm to 12 μm, more preferably from 1 μm to 10 μm, further preferably from 1 μm to 7 μm, particularly preferably from 2 μm to 5 μm. In addition, when the cured layer of the terminal-modified oligomer is too thick, due to the decrease in heat resistance, the laminate may not withstand a high temperature process for mounting a chip thereon, and a metal wiring may be buried into the polyimide layer of the laminate. From this viewpoint, the thickness of the cured layer of the terminal-modified oligomer may be preferably from 0.5 μm to 12 μm, more preferably from 1 μm to 10 μm, further preferably from 1 μm to 7 μm, particularly preferably from 2 μm to 5 μm.

The carboxylic acid compound having an unsaturated group is represented by the general formula (6). The carboxylic acid compound has both an addition polymerizable or crosslinkable unsaturated group containing a carbon-carbon triple bond (acetylene group) or a carbon-carbon double bond (ethylene group) and a dicarboxylic anhydride group, and has a reactive unsaturated group capable of reacting with an adjacent amino group to form an imide bond.

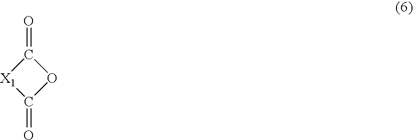

wherein
X₁ represents a divalent group selected from the groups listed as the following formula (7):

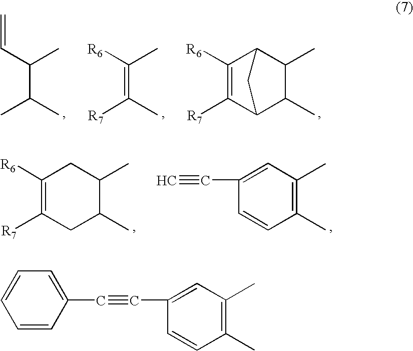

wherein
R₆ and R₇ independently represent —H, —F, —CH₃, —C₂H₅, —CF₃, or -phenyl, and
R₆ and R₇ may be the same as, or different from each other.

Specific examples of the carboxylic acid compound having an unsaturated group include

1) maleic anhydride, and derivatives thereof (for example, dimethylmaleic anhydride, diisopropylmaleic anhydride, and dichloromaleic anhydride);

2) tetrahydrophthalic anhydride, and derivatives thereof;

3) 5-norbornene-2,3-dicarboxylic anhydride (nadic anhydride), and derivatives thereof (for example, methylnadic anhydride, oxynadic anhydride, methyloxynadic anhydride, dimethyloxynadic anhydride, ethylnadic anhydride, and hexachloronadic anhydride);

4) itaconic anhydride; and

5) 4-phenylethynylphthalic anhydride.

These compounds may be used alone or in combination of two or more.

A particularly preferable carboxylic acid compound having an unsaturated group may be a compound containing a reactive double bond, which is represented by the following general formula (6′). Among them, maleic anhydride, and derivatives thereof is particularly preferable because the cured product may have excellent properties and easy-processability, and no reaction product gas may be generated during curing.

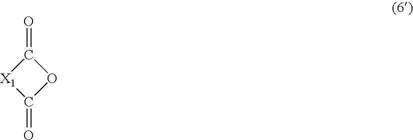

wherein
X₁ represents a divalent group selected from the groups listed as the following formula (7′):

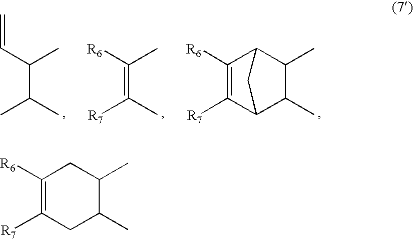

wherein
R₆ and R₇ independently represent —H, —F, —CH₃, —C₂H₅, —CF₃, or -phenyl, and
R₆ and R₇ may be the same as, or different from each other.

The tetracarboxylic dianhydride component to be used may comprise a tetracarboxylic dianhydride represented by the general formula (3), preferably a tetracarboxylic dianhydride represented by the general formula (3′), as a main component. Any known tetracarboxylic dianhydride other than the tetracarboxylic dianhydride represented by the general formula (3) may be used, as long as the characteristics of the present invention would not be impaired. The proportion of the tetracarboxylic dianhydride represented by the general formula (3) in the tetracarboxylic dianhydride component may be preferably 50 mol % or more, more preferably 70 mol % or more, further preferably 80 mol % or more, particularly preferably 90 mol % or more.

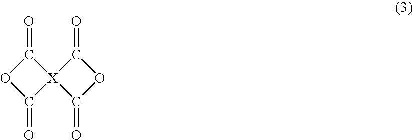

wherein
X represents a tetravalent group selected from the groups listed as the following formula (4):

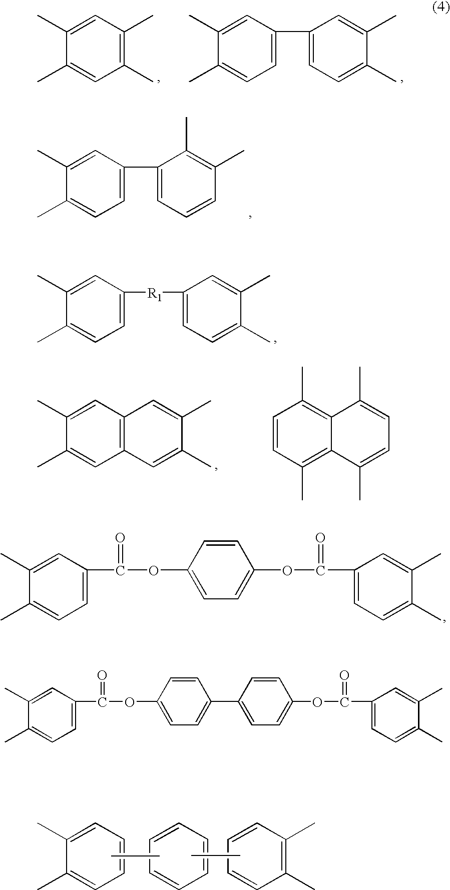

wherein
R₁ represents a divalent group selected from the groups listed as the following formula (5):

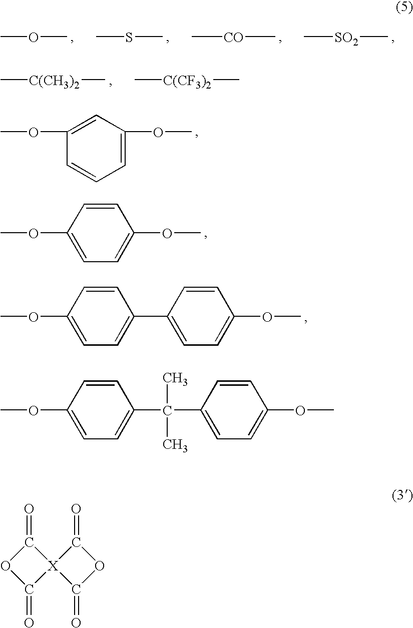

wherein
X represents a tetravalent group selected from the groups listed as the following formula (4′):

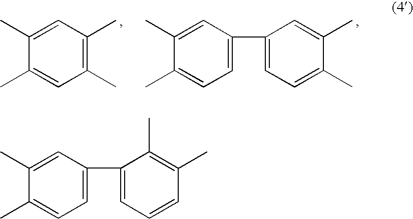

Specific examples of the tetracarboxylic dianhydride may include pyromellitic dianhydride, 3,3′,4,4′-biphenyltetracarboxylic dianhydride, 2,3′,3,4′-biphenyltetracarboxylic dianhydride, oxydiphthalic dianhydride, diphenyl sulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 3,3′,4,4′-benzophenone tetracarboxylic dianhydride, bis(3,4-dicarboxyphenyl)methane dianhydride, 2,2-bis(3,4-dicarboxyphenyl)propane dianhydride, p-phenylene bis(trimellitic acid monoester anhydride), p-biphenylene bis(trimellitic acid monoester anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride, 2,3,6,7-naphthalene tetracarboxylic dianhydride, and 1,4,5,8-naphthalene tetracarboxylic dianhydride. These may be used alone or in combination of two or more.

In addition to the tetracarboxylic dianhydride represented by the general formula (3), an aliphatic tetracarboxylic dianhydride, an alicyclic tetracarboxylic dianhydride, and a silicon-containing tetracarboxylic dianhydride may be used, as long as the characteristics of the present invention would not be impaired.

An aromatic diamine having 2 to 4 benzene rings may be suitably used as a diamine component. The diamine component to be used may comprise a diamine represented by the general formula (1), preferably a diamine represented by the general formula (1′), as a main component. Any known diamine other than the diamine represented by the general formula (1) may be used, as long as the characteristics of the present invention would not be impaired. The proportion of the diamine represented by the general formula (1) in the diamine component may be preferably 50 mol % or more, more preferably 70 mol % or more, further preferably 80 mol % or more, particularly preferably 90 mol % or more.

H₂N—Y—NH₂ (1)

wherein
Y represents a divalent group selected from the groups listed as the following formula (2):

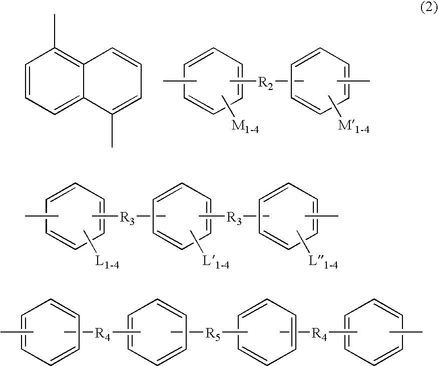

wherein
R₂, R₃, R₄ and R₅ independently represent a single bond, or a divalent group selected from the group consisting of —O—, —S—, —CO—, —SO₂—, —CH₂—, —C(CH₃)₂—, and —C(CF₃)₂—, and

M₁-M₄, M′₁-M′₄, L₁-L₄, L′₁-L′₄ and L″₁-L″₄ independently represent —H, —F, —Cl, —Br, —I, —CN, —OCH₃, —OH, —COOH, —CH₃, —C₂H₅, or —CF₃.

R₂, R₃, R₄ and R₅ may be the same as, or different from each other, and M₁-M₄, M′₁-M′₄, L₁-L₄, L′₁-L′₄ and L″₁-L″₄ may be the same as, or different from each other.

H₂N—Y—NH₂ (1′)

wherein
Y represents a divalent group selected from the groups listed as the following formula (2′):

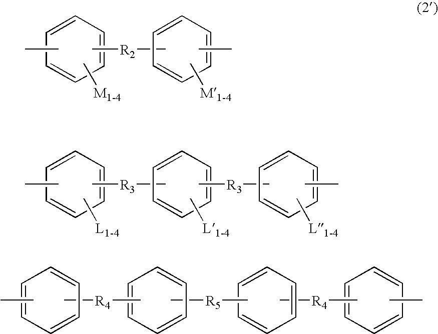

wherein
R₂ represents a single bond, or a divalent group selected from the group consisting of —O—, —S—, —CH₂—, and —C(CH₃)₂—,
R₃ and R₄ independently represent —O—, or —S—,
R₅ represents a single bond, or a divalent group selected from the group consisting of —O—, —CH₂—, and —C(CH₃)₂—, and
M₁-M₄, M′₁-M′₄, L₁-L₄, L′₁-L′₄ and L″₁-L″₄ independently represent —H, or —CH₃.

R₂, R₃, R₄ and R₅ may be the same as, or different from each other, and M₁-M₄, M′₁-M′₄, L₁-L₄, L′₁-L′₄ and L″₁-L″₄ may be the same as, or different from each other.

Specific examples of the diamine may include 3,3′-dichlorobenzidine, 3,3′-dimethylbenzidine, 2,2′-dimethylbenzidine, 3,3′-dimethoxybenzidine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene, 1,4-bis(4-aminophenoxy)benzene, 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenyl sulfide)benzene, 1,3-bis(4-aminophenyl sulfide)benzene, 1,4-bis(4-aminophenyl sulfide)benzene, 1,3-bis(3-aminophenyl sulfone)benzene, 1,3-bis(4-aminophenyl sulfone)benzene, 1,4-bis(4-aminophenyl sulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane. These may be used alone or in combination of two or more.

In addition to the diamine represented by the general formula (1), an aliphatic diamine, an alicyclic diamine, a silicon-containing diamine, and a monobenzene diamine such as p-phenylenediamine, m-phenylenediamine, and o-phenylenediamine may be used, as long as the characteristics of the present invention would not be impaired.

In the present invention, the cured product of the terminal-modified oligomer may be preferably obtained by reacting an imide oligomer component comprising an imide oligomer represented by the following general formula (8) with a carboxylic acid compound having an unsaturated group which is represented by the above general formula (6). A preferable cured product of the terminal-modified oligomer may be obtained by reacting an amino terminal of an imide oligomer component, which comprises an imide oligomer represented by the following general formula (8) in an amount of 50% or more, more preferably 60% or more, further preferably 70% or more, further preferably 80% or more, particularly preferably 90% or more based on the total amount of the oligomer, with a carboxylic acid compound having an unsaturated group which is represented by the above general formula (6). The proportion of the imide oligomer represented by the general formula (8) in the imide oligomer component may be measured with GPC.

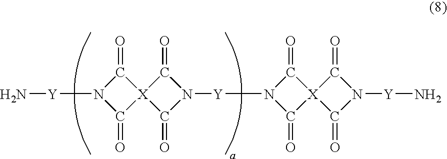

wherein
a is a number of 1, 2, 3, 4, 5, 6, 7, 8, 9, 10, 11, or 12,
Y represents a divalent group selected from the groups listed as the following formula (2), and
X represents a tetravalent group selected from the groups listed as the following formula (4).

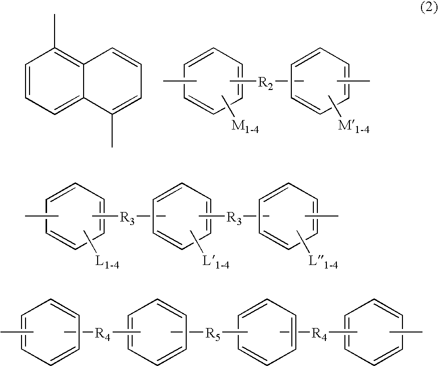

wherein
R₂, R₃, R₄ and R₅ independently represent a single bond, or a divalent group selected from the group consisting of —O—, —S—, —CO—, —SO₂—, —CH₂—, —C(CH₃)₂—, and —C(CF₃)₂—,
M₁-M₄, M′₁-M′₄, L₁-L₄, L′₁-L′₄ and L″₁-L″₄ independently represent —H, —F, —Cl, —Br, —I, —CN, —OCH₃, —OH, —COOH, —CH₃, —C₂H₅, or —CF₃.
R₂, R₃, R₄ and R₅ may be the same as, or different from each other, and M₁-M₄, M′₁-M′₄, L₁-L₄, L′₁-L′₄ and L″₁-L″₄ may be the same as, or different from each other.

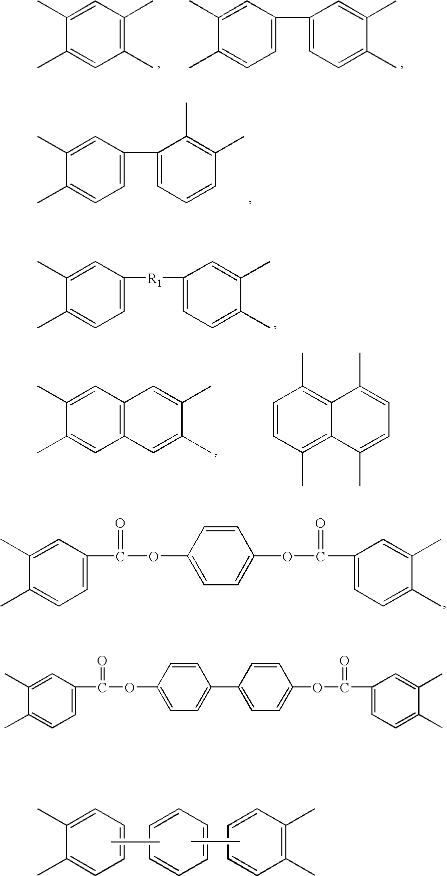

wherein
R₁ represents a divalent group selected from the groups listed as the following formula (5):

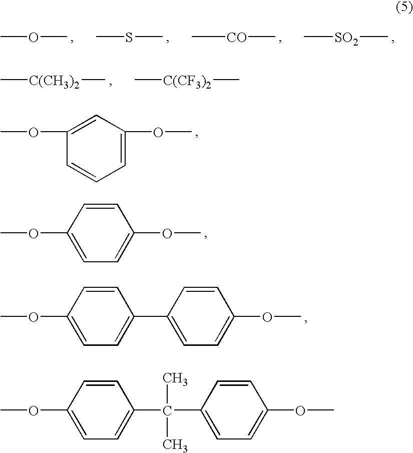

In the case of the terminal-modified oligomer obtained by reacting an amino terminal of an imide oligomer component comprising an imide oligomer represented by the above general formula (8) with a carboxylic acid compound having an unsaturated group which is represented by the above general formula (6), the softening temperature and/or the curing initiation temperature of the terminal-modified oligomer tends to be higher as the value of a is greater.

In the case of the terminal-modified oligomer obtained by reacting an amino terminal of an imide oligomer component comprising an imide oligomer represented by the above general formula (8) with a carboxylic acid compound having an unsaturated group which is represented by the above general formula (6), the softening temperature of the terminal-modified oligomer tends to be lower as the number of benzene rings contained in the diamine is more when the value of a is constant.

Examples of the process for producing a terminal-modified oligomer may include

1) a process in which a “terminal-modified imide precursor oligomer” is obtained by reacting a tetracarboxylic dianhydride component and a diamine component in a molar ratio of n:(n+1) (n is a number of 2 to 6) and a carboxylic acid compound having an unsaturated group in an organic polar solvent at a reaction temperature of about 100° C. or lower, preferably about 80° C. or lower, particularly preferably from 0° C. to 50° C.;

2) a process in which a “terminal-modified imide precursor oligomer” is obtained by reacting a tetracarboxylic dianhydride component and a diamine component in a molar ratio of n:(n+1) (n is a number of 2 to 6) and a carboxylic acid compound having an unsaturated group in an organic polar solvent at a reaction temperature of about 100° C. or lower, preferably about 80° C. or lower, particularly preferably from 0° C. to 50° C.; and then

a terminal-modified imide oligomer having an unsaturated group at its molecular terminal is obtained by the cyclodehydration of the terminal-modified imide precursor oligomer; specifically, by adding an imidizing agent to the terminal-modified imide precursor oligomer at a low temperature of from about 0° C. to about 140° C., or alternatively, by heating the terminal-modified imide precursor oligomer to a temperature equal to or higher than 140° C., and lower (preferably by not less than 5° C., more preferably by not less than 10° C., particularly preferably by not less than 15° C.) than the curing initiation temperature of the terminal-modified imide oligomer;

3) a process in which an “imide precursor oligomer” is obtained by reacting a tetracarboxylic dianhydride component and a diamine component in a molar ratio of n:(n+1) (n is a number of 2 to 6) in an organic polar solvent at a reaction temperature of about 100° C. or lower, preferably about 80° C. or lower, particularly preferably from 0° C. to 50° C.; and then

a “terminal-modified imide precursor oligomer” is obtained by reacting the imide precursor oligomer with a carboxylic acid compound having an unsaturated group in an organic polar solvent at a reaction temperature of about 100° C. or lower, preferably about 80° C. or lower, particularly preferably from 0° C. to 50° C.;

4) a process in which an “imide precursor oligomer” is obtained by reacting a tetracarboxylic dianhydride component and a diamine component in a molar ratio of n:(n+1) (n is a number of 2 to 6) in an organic polar solvent at a reaction temperature of about 100° C. or lower, preferably about 80° C. or lower, particularly preferably from 0° C. to 50° C.;

a “terminal-modified imide precursor oligomer” is obtained by reacting the imide precursor oligomer with a carboxylic acid compound having an unsaturated group in an organic polar solvent at a reaction temperature of about 100° C. or lower, preferably about 80° C. or lower, particularly preferably from 0° C. to 50° C.; and then a terminal-modified imide oligomer having an unsaturated group at its molecular terminal is obtained by the cyclodehydration of the terminal-modified imide precursor oligomer; specifically, by adding an imidizing agent to the terminal-modified imide precursor oligomer at a low temperature of from about 0° C. to about 140° C., or alternatively, by heating the terminal-modified imide precursor oligomer to a temperature equal to or higher than 140° C., and lower (preferably by not less than 5° C., more preferably by not less than 10° C., particularly preferably by not less than 15° C.) than the curing initiation temperature of the terminal-modified imide oligomer; and

5) a process in which a terminal-modified imide oligomer having an unsaturated group at its molecular terminal is obtained by adding an imidizing agent to a reactant composition, i.e. a tetracarboxylic dianhydride component and a diamine component in a molar ratio of n:(n+1) (n is a number of 2 to 6) and a carboxylic acid compound having an unsaturated group, in an organic polar solvent at a low temperature of from about 0° C. to about 140° C. for cyclodehydration, or alternatively, by heating a reactant composition, i.e. a tetracarboxylic dianhydride component and a diamine component in a molar ratio of n:(n+1) (n is a number of 2 to 6) and a carboxylic acid compound having an unsaturated group, in an organic polar solvent to a temperature equal to or higher than 140° C., and lower (preferably by not less than 5° C., more preferably by not less than 10° C., particularly preferably by not less than 15° C.) than the curing initiation temperature of the terminal-modified imide oligomer for cyclodehydration.

After a terminal-modified imide oligomer or a terminal-modified imide precursor oligomer is synthesized in an organic polar solvent, the solution of the terminal-modified imide oligomer or the terminal-modified imide precursor oligomer may be applied to a heat resistant film and/or a metal foil without isolation of the oligomer to form a terminal-modified imide oligomer layer. The terminal-modified imide oligomer solution obtained or the terminal-modified imide precursor oligomer solution obtained may be used without any treatment, or may be used after removing or adding a solvent, if necessary. Alternatively, after a terminal-modified imide oligomer or a terminal-modified imide precursor oligomer is synthesized in an organic polar solvent, the oligomer is precipitated with a poor solvent and dried, and then the oligomer is dissolved in another organic polar solvent, thereby preparing a clear solution, which is used to form a terminal-modified imide oligomer layer.

Examples of the organic polar solvent to be used for the preparation of the oligomer and the terminal-modified oligomer include any known organic polar solvents used for the preparation of high-molecular-weight aromatic polyimides and polyimide precursors, for example, aprotic polar solvents, ether solvents, water-soluble alcohol compounds, and the like. Specific examples of the organic polar solvent include amide solvents such as N,N-dimethylacetamide, N,N-diethylacetamide, N,N-dimethylformamide, N,N-diethylformamide, and N-methyl-2-pyrrolidone; solvents containing a sulfur atom such as dimethylsulfoxide, diethylsulfoxide, dimethylsulfone, diethylsulfone, and hexamethylsulfoformamide; phenol solvents such as cresol, phenol, xylenol, p-chlorophenol, and o-chlorophenol; solvents containing an oxygen atom such as ethylene glycol, 1,3-dioxane, 1,4-dioxane, tetrahydrofuran, diglyme, and triglyme; and other solvents such as pyridine, tetramethyl urea, and dimethylsulfone. Furthermore, aromatic hydrocarbon solvents such as benzene, toluene, and xylene; and other organic solvents such as solvent naphtha, and benzylnitrile may be used in combination with at least one of these organic solvents, as necessary.

The above-mentioned surface treatment agents and/or any known surfactant may be added to an organic polar solvent, as long as the characteristics of the present invention would not be impaired.

According to the present invention, it is preferable to form a terminal-modified oligomer layer (a layer of a terminal-modified oligomer selected from a terminal-modified imide oligomer and a terminal-modified imide precursor oligomer) on a heat resistant film and/or a metal foil; laminate the metal foil on the heat resistant film via the terminal-modified oligomer; and then polymerizing the terminal-modified oligomer by the addition reaction and/or cross-linking reaction, for example, by heating the terminal-modified oligomer to give a cured layer of the terminal-modified oligomer.

The cured product of the terminal-modified oligomer may be preferably obtained by heating a terminal-modified oligomer to a temperature equal to or higher than the temperature lower by 10° C., more preferably lower by 5° C., than the curing initiation temperature of the terminal-modified oligomer.

According to the present invention, a terminal-modified oligomer layer may be formed on a heat resistant film and/or a metal foil by applying a terminal-modified oligomer solution to one side or both sides of a heat resistant film or one side of a metal foil; removing the solvent contained in the solution applied to the heat resistant film or the metal foil; and, if the terminal-modified oligomer comprises a polyimide precursor, heating the heat resistant film or the metal foil having the terminal-modified oligomer thereon to effect imidization, for example.

Examples of the process for forming a terminal-modified oligomer layer on a heat resistant film and/or a metal foil may include

1) a process in which a terminal-modified imide precursor oligomer solution is applied to a heat resistant film and/or a metal foil; the solvent contained in the solution is removed; and then the heat resistant film and/or the metal foil having the terminal-modified imide precursor oligomer thereon is heated to a temperature equal to or higher than 140° C. and lower (preferably by not less than 5° C., more preferably by not less than 10° C., particularly preferably by not less than 15° C.) than the curing initiation temperature of the terminal-modified imide oligomer obtained to effect imidization; and

2) a process in which a terminal-modified imide precursor oligomer solution is applied to a heat resistant film and/or a metal foil; and then the solvent and water contained in the solution is removed.

When applying a terminal-modified oligomer solution to a metal foil and/or a heat resistant film, the terminal-modified oligomer solution may comprise an additive. For the purpose of improving coating properties and adhesive properties, a coupling agent such as a silane coupling agent may be preferably added to the terminal-modified oligomer solution, for example. Any known coupling agent may be used in the present invention. A preferable coupling agent may be a silane coupling agent such as N-phenyl-3-aminopropyl trimethoxy silane, 3-methacryloxypropyl trimethoxy silane, and 3-glycidoxypropyl trimethoxy silane. The amount of the coupling agent to be added may be appropriately selected. It may be preferably from about 1 wt % to about 5 wt % based on the solid content of the terminal-modified oligomer.

A surfactant and an anti-foaming agent may be added to the terminal-modified oligomer solution so as to finely apply the terminal-modified oligomer solution to a heat resistant film and/or a metal foil.

Furthermore, in the present invention, a radical generator capable of generating oxygen radicals or carbon radicals may be preferably added to the terminal-modified oligomer solution preferably in an amount of 0.1 wt % to 10 wt % based on the solid content of the terminal-modified oligomer so as to accelerate the reaction of the oligomer layer.

Any known radical generator capable of generating oxygen radicals or carbon radicals by heat may be used in the present invention. A radical generator exhibiting decomposition behavior in which the curing reaction does not excessively proceed under drying conditions may be preferably selected for use. Specific examples of the radical generator include cumene hydroperoxide, t-butyl hydroperoxide, and 2,3-dimethyl-2,3-diphenylbutane. The radical generators may be used alone or in combination of two or more.

The amount of the radical generator to be added may be preferably from 0.1 wt % to 10 wt %, more preferably from 0.1 wt % to 5 wt %, particularly preferably from 0.5 wt % to 5 wt %, based on the solid content of the terminal-modified oligomer. When an excessively small amount of radical generator is added, the desired effect may not be achieved. When an excessively large amount of radical generator is added, adhesive strength may be reduced.

The terminal-modified oligomer solution may be applied to a heat resistant film and/or a metal foil by any known method; for example, by gravure coating, spin coating, silk screen coating, dip coating, spray coating, bar coating, knife coating, roll coating, blade coating, and die coating.

When applying a terminal-modified oligomer solution to a heat resistant film and/or a metal foil, a solvent having excellent coating properties may be preferably selected for use. Preferable examples of the solvent include amide solvents such as N,N-dimethylacetamide and N-methyl-2-pyrrolidone; a mixed solvent comprising a solvent containing a sulfur atom such as dimethylsulfoxide, and a solvent containing an oxygen atom such as diglyme and triglyme; and a solvent comprising an additive such as a silane coupling agent and a surfactant.

The temperature at which a terminal-modified oligomer solution is applied to a metal foil and/or a heat resistant film may be appropriately selected. It may be a temperature at which the solvent is not significantly volatilized, a temperature at which the solvent is not significantly oxidized, a temperature at which the terminal groups of the terminal-modified oligomer are not significantly reacted, or a temperature at which the solvent is not significantly solidified, for example.

After applying a terminal-modified oligomer solution to a metal foil and/or a heat resistant film, the solvent is removed. The drying temperature for solvent removal may be appropriately selected depending on the properties of the solvent, and it should be a temperature lower (preferably by not less than 5° C., more preferably by not less than 10° C., particularly preferably by not less than 15° C.) than the curing initiation temperature of the terminal-modified imide oligomer. Specifically, drying may be preferably conducted at a temperature of from 50° C. to about 230° C. for about 1 min to about 10 hours, preferably about 2 min to about 10 min. When the solvent is insufficiently removed and the imidization reaction insufficiently proceeds, or when the drying is insufficient, foaming may occur readily during thermocompression bonding and a heating step (annealing step), and adhesive strength may be reduced.

In the process for producing a laminate of a heat resistant film and a metal foil of the present invention, the laminate may be preferably produced by pressing a laminate at a temperature equal to or higher than the temperature of around the softening temperature of the terminal-modified oligomer, and then heating the laminate at a temperature equal to or higher than the temperature of around the curing initiation temperature of the terminal-modified oligomer; or alternatively, by heating and pressing a laminate at a temperature equal to or higher than the temperature of around the curing initiation temperature of the terminal-modified oligomer. Preferable examples of the process for producing a laminate of a heat resistant film and a metal foil of the present invention may include the following processes.

Production Process (A):

A process for producing a laminate of a heat resistant film and a metal foil comprising:

(a1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon, i.e. laminating a metal foil on a heat resistant film such that the terminal-modified oligomer layer of the metal foil is in contact with the heat resistant film, or such that the metal foil is in contact with the terminal-modified oligomer layer of the heat resistant film, or such that the terminal-modified oligomer layer of the metal foil is in contact with the terminal-modified oligomer layer of the heat resistant film; and

pressing the laminate of the heat resistant film, the terminal-modified oligomer layer and the metal foil at a temperature equal to or higher than the temperature lower by 10° C. than the softening temperature of the terminal-modified oligomer, preferably at a temperature equal to or higher than the temperature lower by 5° C. than the softening temperature of the terminal-modified oligomer, more preferably at a temperature equal to or higher than the softening temperature of the terminal-modified oligomer, further preferably at a temperature equal to or higher than the temperature higher by 5° C. than the softening temperature of the terminal-modified oligomer, particularly preferably at a temperature equal to or higher than the temperature higher by 10° C. than the softening temperature of the terminal-modified oligomer, using a laminating machine; and

(a2) a step of heating, or alternatively, heating and pressing the pressed laminate of the heat resistant film, the terminal-modified oligomer layer and the metal foil up to a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer, using a laminating machine or a heating machine.

Production Process (B):

A process for producing a laminate of a heat resistant film and a metal foil comprising:

(b1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon, i.e. laminating a metal foil on a heat resistant film such that the terminal-modified oligomer layer of the metal foil is in contact with the heat resistant film, or such that the metal foil is in contact with the terminal-modified oligomer layer of the heat resistant film, or such that the terminal-modified oligomer layer of the metal foil is in contact with the terminal-modified oligomer layer of the heat resistant film; and

heating and pressing the laminate at a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer, using a laminating machine.

A terminal-modified oligomer may be cured by heat in step (a2) in production process (A) or step (b1) in production process (B) as described above.

A heat resistant film having a terminal-modified oligomer layer thereon, a heat resistant film, a metal foil having a terminal-modified oligomer layer thereon, and a metal foil may be preferably preheated before fed into a laminating machine or a heating machine so as to remove a solvent contained therein and water absorbed therein. The preheating temperature may be preferably from about 70° C. to about 150° C.

In the process for producing a laminate of a heat resistant film and a metal foil of the present invention, for example, in step (a1) in production process (A) and step (b1) in production process (B) as described above,

a metal foil may be laminated on a heat resistant film having a terminal-modified oligomer layer, preferably with a thickness of 0.5 μm to 15 μm, thereon such that the metal foil is in contact with the terminal-modified oligomer layer of the heat resistant film;

a heat resistant film may be laminated on a metal foil having a terminal-modified oligomer layer, preferably with a thickness of 0.5 μm to 15 μm, thereon such that the heat resistant film is in contact with the terminal-modified oligomer layer of the metal foil; or

a heat resistant film having a terminal-modified oligomer layer thereon may be laminated on a metal foil having a terminal-modified oligomer layer thereon such that the terminal-modified oligomer layer of the heat resistant film is in contact with the terminal-modified oligomer layer of the metal foil (When one terminal-modified oligomer layer is on the other, the total thickness of the terminal-modified oligomer layers may be preferably 0.5 μm to 15 μm.);

for the production of a laminate having a metal foil on one side of a heat resistant film, for example.

In the process for producing a laminate of a heat resistant film and a metal foil of the present invention, for example, in step (a1) in production process (A) and step (b1) in production process (B) as described above,

two metal foils may be laminated on both sides of a heat resistant film having a terminal-modified oligomer layer, preferably with a thickness of 0.5 lam to 15 μm, on both sides thereof;

a metal foil, a heat resistant film having a terminal-modified oligomer layer on both sides thereof, and a terminal-modified oligomer layer of a metal foil, which has a terminal-modified oligomer layer on one side thereof, may be laminated in this order (When one terminal-modified oligomer layer is on the other, the total thickness of the terminal-modified oligomer layers may be preferably 0.5 μm to 15 μm.);

a terminal-modified oligomer layer of a metal foil, which has a terminal-modified oligomer layer on one side thereof, a heat resistant film having a terminal-modified oligomer layer on both sides thereof, and a terminal-modified oligomer layer of a metal foil, which has a terminal-modified oligomer layer on one side thereof, may be laminated in this order; or

a terminal-modified oligomer layer of a metal foil, which has a terminal-modified oligomer layer on one side thereof, a heat resistant film, and a terminal-modified oligomer layer of a metal foil, which has a terminal-modified oligomer layer on one side thereof, may be laminated in this order; for the production of a laminate having a metal foil on both sides of a heat resistant film, for example.

When laminating a metal foil having a terminal-modified oligomer layer thereon on a heat resistant film having a terminal-modified oligomer layer thereon such that the terminal-modified oligomer layer of the metal foil is in contact with the terminal-modified oligomer layer of the heat resistant film, the total thickness of the terminal-modified oligomer layers between the metal foil and the heat resistant film may be preferably from 0.5 μm to 15 μm.

In the process for producing a laminate of a heat resistant film and a metal foil, thermocompression bonding of a metal foil, a terminal-modified oligomer layer and a heat resistant film may be preferably conducted at a temperature equal to or higher than the temperature lower by 10° C. than the softening temperature of the terminal-modified oligomer, preferably at a temperature equal to or higher than the temperature lower by 5° C. than the softening temperature of the terminal-modified oligomer, more preferably at a temperature equal to or higher than the softening temperature of the terminal-modified oligomer, further preferably at a temperature equal to or higher than the temperature higher by 5° C. than the softening temperature of the terminal-modified oligomer, particularly preferably at a temperature equal to or higher than the temperature higher by 10° C. than the softening temperature of the terminal-modified oligomer, for the predetermined time period. The “predetermined time period” is a time period required for bonding a metal foil, a terminal-modified oligomer layer and a heat resistant film at a temperature selected for thermocompression bonding. It may vary according to the materials to be used.

According to the present invention, thermocompression bonding of a metal foil, a terminal-modified oligomer layer and a heat resistant film may be conducted at a temperature lower than the softening temperature of the terminal-modified oligomer. The reason appears to be that the oligomer has molecular-weight distribution and comprises a low-molecular-weight compound.

The cured product of the terminal-modified oligomer may be prepared by heating a terminal-modified oligomer such as a terminal-modified imide oligomer and a terminal-modified imide precursor oligomer at a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer, to polymerize the terminal-modified oligomer by the addition reaction and/or cross-linking reaction involving a terminal modifying group such as a reactive double bond and a reactive triple bond.

In the process for producing a laminate of a heat resistant film and a metal foil, the cured product of the terminal-modified oligomer may be obtained by heating a terminal-modified oligomer to a temperature equal to or higher than the temperature lower by 10° C. than the curing initiation temperature of the terminal-modified oligomer, preferably at a temperature equal to or higher than the temperature lower by 5° C. than the curing initiation temperature of the terminal-modified oligomer, more preferably at a temperature equal to or higher than the curing initiation temperature of the terminal-modified oligomer, further preferably at a temperature equal to or higher than the temperature higher by 5° C. than the curing initiation temperature of the terminal-modified oligomer, particularly preferably at a temperature equal to or higher than the temperature higher by 10° C. than the curing initiation temperature of the terminal-modified oligomer, for the predetermined time period. The “predetermined time period” is a time period required for reacting a terminal modifying group such as a reactive double bond and a reactive triple bond of a terminal-modified oligomer under heating conditions to polymerize and/or cross-link the terminal-modified oligomer. It may vary according to the materials to be used.

According to the present invention, a cured product of a terminal-modified oligomer may be formed at a temperature lower than the curing initiation temperature of the terminal-modified oligomer. The reason appears to be that the oligomer has molecular-weight distribution and comprises a low-molecular-weight compound.

A cured product of a terminal-modified oligomer may be generally formed by heating the terminal-modified oligomer, although the curing process is not limited to a thermal curing process. When the addition reaction and/or cross-linking reaction is conducted by heating the terminal-modified oligomer, the heating temperature should be around the curing initiation temperature of the terminal-modified oligomer, or higher. Although the heating temperature may vary according to the terminal-modified oligomer to be used, it may be from about 230° C. to about 400° C., preferably from 240° C. to 400° C. The heating time may be from about 1 sec to about 20 hours, preferably from about 10 sec to about 10 hours, more preferably from about 1 min to about 5 hours. Furthermore, as described above, when a radical generator is added preferably in an amount of 0.1 wt % to 10 wt % based on the solid content of the terminal-modified oligomer, the high adhesive strength may be achieved by reacting a terminal-modified oligomer at a lower temperature for a shorter time.

The heat treatment may be conducted using any known apparatus such as a hot-air oven and an infrared heating oven. The heat treatment may be conducted in an air atmosphere, or in an inert gas atmosphere such as in nitrogen atmosphere and in argon atmosphere. The heat treatment may be preferably conducted in an inert gas atmosphere such as in nitrogen atmosphere and in argon atmosphere because a metal and a heat resistant film may not be readily discolored and oxidized in an inert gas.

Examples of the laminating machine include a pair of press metal rolls in which the press part is made of either a metal or a ceramic sprayed coating metal, a vacuum laminating machine, a double-belt press, and a hot-press. A preferable laminating machine may be one capable of conducting thermo-compression bonding and cooling under pressure, and a hydraulic-press type double-belt press is particularly preferable.

The laminate of a heat resistant film and a metal foil of the present invention may be used as a material for an electronic component or an electronic device such as a printed wiring board, a flexible printed circuit board, COF, COB and TAB tapes.

The laminate of a heat resistant film and a metal foil of the present invention may preferably have an adhesive strength of 0.6 N/mm or higher, preferably 0.7 N/mm or higher, further preferably 0.8 N/mm or higher, and an upper limit temperature for soldering of 300° C. or higher, preferably 320° C. or higher, further preferably 340° C. or higher, particularly preferably 350° C. or higher. The laminate of the present invention may preferably have neither crack nor foaming in the laminated portion. According to the present invention, such a laminate may be easily produced.

A terminal-modified oligomer may comprise other cross-linkable components such as a cross-linkable acrylic resin, a cross-linkable ester resin, a cross-linkable urethane resin, and an epoxy resin.

A terminal-modified oligomer may comprise a polyimide having heat resistance to a temperature higher than the heating temperature for the terminal-modified oligomer, a thermoplastic or thermosetting resin particle such as a polyimide particle, an inorganic particle such as silica, barium sulfate, calcium carbonate, and titanium dioxide, a metallic particle, and the like.

### EXAMPLES

The present invention will be more specifically described below with reference to the Examples. However, the present invention is not limited to the following Examples.

### (Evaluation Method)

1) Terminal-Modified Oligomer

Softening Temperature of a Terminal-Modified Oligomer:

The DSC measurement was carried out from room temperature to 400° C. at a heating rate of 10° C./min without holding in nitrogen gas atmosphere, using DSC-50 manufactured by SHIMADZU CORPORATION, and the peak corresponding to the softening temperature and the changing point corresponding to the curing initiation temperature were determined in the measured data.

2) Laminate

90° peel strength (adhesive strength):

The 90° peel strength of a laminate was measured at a peel speed of 50 mm/min, using a sample with a width of 10 mm (in accordance with JIS C6471).

Resistance to Soldering Heat:

A sample was left in an atmosphere at 23° C. and 60% RH for 24 hours for humidity-conditioning. Subsequently, the sample was floated on a liquid solder at the predetermined temperature for 10 sec, and the presence or absence of foaming and blister were observed. The temperature at which neither foaming nor blister was observed was determined as resistance to soldering heat.

Evaluation of the Laminated Portion:

The presence or absence of foaming and the like in the laminated portion of a copper foil and a polyimide film in a laminate was evaluated by visual observation.

(∘: no foaming was observed; x: a foaming was observed.)

Tool Press Test:

After forming a circuit on the laminate, pressure was applied on the copper wiring at a tool temperature of 450° C. at a pressure of 15 kg/mm² for 2 sec, using Avio Super Welder NA-620, and the presence or absence of copper wiring breakage, the presence or absence of foaming between the copper wiring and the base film, and the depth of the copper wiring buried in the base film were evaluated.

The materials used in the Examples are represented by the following abbreviations.

### (Tetracarboxylic Dianhydride)

2,3,3′,4′-biphenyltetracarboxylic dianhydride: a-BP,

3,3′,4,4′-biphenyltetracarboxylic dianhydride: s-BP,

pyromellitic dianhydride: PMDA,

3,3′,4,4′-benzophenone tetracarboxylic dianhydride: BTDA.

### (Diamine Component)

1,4-diaminobenzene: PPD,

4,4′-diaminodiphenyl ether: DDE,

1,3-bis(4-aminophenoxy)benzene: TPE-R,

1,3-bis(3-aminophenoxy)benzene: APB,

2,2-bis(4-aminophenoxyphenyl)propane: BAPP.

### (Carboxylic Acid Compound Having an Unsaturated Group)

maleic anhydride: MAD.

### (Solvent)

N-methyl-2-pyrrolidone: NMP,

N,N-dimethylacetamide: DMAc,

diethylene glycol dimethyl ether: diglyme.

### Synthesis Example 1

### Solution A

In a separable flask were placed 320 g of NMP, 42.2272 g of TPE-R, 28.3306 g of a-BP and 9.6311 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in NMP (Solution A). The solution was transparent.

(molar ratio of the materials: a-BP:TPE-R:MAD=2:3:2)

### Synthesis Example 2

### Solution B

In a separable flask were placed 320 g of DMAc, 42.2272 g of TPE-R, 28.3306 g of a-BP. Then, the mixture was stirred in nitrogen gas atmosphere at 50° C. for 1 hour, and then heated to 160° C. and stirred at 160° C. for 3 hours, to prepare an oligomer having an amine terminal. After cooling down to room temperature, 9.6311 g of MAD was added to the solution. Then, the mixture was stirred in nitrogen gas atmosphere at 50° C. for 1 hour, and then heated to 160° C. and stirred at 160° C. for 3 hours, to obtain a solution of a terminal-modified imide oligomer in DMAc (Solution B). The solution was transparent.

(molar ratio of the materials: a-BP:TPE-R:MAD=2:3:2)

### Synthesis Example 3

### Solution C

In a separable flask were placed 320 g of NMP, 42.2272 g of TPE-R, 28.3306 g of a-BP and 9.6311 g of MAD. Then, the mixture was stirred in nitrogen gas atmosphere at 50° C. for 1 hour, to obtain a solution of a terminal-modified imide precursor oligomer in NMP (Solution C). The solution was transparent.

(molar ratio of the materials: a-BP:TPE-R:MAD=2:3:2)

### Synthesis Example 4: Solution D

In a separable flask were placed 320 g of NMP, 34.6916 g of DDE, 33.9824 g of a-BP and 11.5525 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in NMP (Solution D). The solution was transparent.

(molar ratio of the materials: a-BP:DDE:MAD=2:3:2)

### Synthesis Example 5

### Solution E

In a separable flask were placed 320 g of DMAc, 42.2272 g of TPE-R, 28.3306 g of s-BP and 9.6311 g of MAD. Then, the mixture was stirred in nitrogen gas atmosphere at 50° C. for 1 hour, to obtain a solution of a terminal-modified imide precursor oligomer in DMAc (Solution E). The solution was transparent.

(molar ratio of the materials: s-BP:TPE-R:MAD=2:3:2)

### Synthesis Example 6

### Solution F

In a separable flask were placed 320 g of DMAc, 46.4851 g of TPE-R, 23.1206 g of PMDA and 10.6039 g of MAD. Then, the mixture was stirred in nitrogen gas atmosphere at 50° C. for 1 hour, to obtain a solution of a terminal-modified imide precursor oligomer in DMAc (Solution F). The solution was transparent.

(molar ratio of the materials: PMDA:TPE-R:MAD=2:3:2)

### Synthesis Example 7

### Solution G

In a separable flask were placed 320 g of DMAc, 52.8580 g of BAPP, 18.7242 g of PMDA and 8.5942 g of MAD. Then, the mixture was stirred in nitrogen gas atmosphere at 50° C. for 1 hour, to obtain a solution of a terminal-modified imide precursor oligomer in DMAc (Solution C). The solution was transparent.

(molar ratio of the materials: PMDA:BAPP:MAD=2:3:2)

### Synthesis Example 8

### Solution H

In a separable flask were placed 320 g of DMAc, 37.2545 g of TPE-R, 2.7560 g of PPD, 29.9932 g of a-BP and 10.1963 g of MAD. Then, the mixture was stirred in nitrogen gas atmosphere at 50° C. for 1 hour, to obtain a solution of a terminal-modified imide precursor oligomer in NMP (Solution M. The solution was transparent.

(molar ratio of the materials: a-BP:TPE-R:PPD:MAD=2:2.5:0.5:2)

### Synthesis Example 9

### Solution I

In a separable flask were placed 224 g of DMAc, 96 g of diglyme, 42.2272 g of TPE-R, 28.3306 g of a-BP and 9.6311 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in DMAc/diglyme mixed solvent (Solution I). The solution was transparent.

(mixing ratio of the solvent (weight ratio): DMAc:diglyme=7:3)
(molar ratio of the materials: a-BP:TPE-R:MAD=2:3:2)

### Synthesis Example 10

### Solution J

In a separable flask were placed 160 g of DMAc, 160 g of diglyme, 42.2272 g of TPE-R, 28.3306 g of a-BP and 9.6311 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in DMAc/diglyme mixed solvent (Solution J). The solution was transparent.

(mixing ratio of the solvent (weight ratio): DMAc:diglyme=1:1)
(molar ratio of the materials: a-BP:TPE-R:MAD=2:3:2)

### Synthesis Example 11

### Solution K

In a separable flask were placed 320 g of DMAc, 46.2244 g of TPE-R, 27.5740 g of a-BP and 6.3257 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in DMAc (Solution K). The solution was transparent.

(molar ratio of the materials: a-BP:TPE-R:MAD=4:5:2)

### Synthesis Example 12

### Solution L

In a separable flask were placed 320 g of DMAc, 40.8491 g of TPE-R, 35.2363 g of a-BP and 3.9146 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in DMAc (Solution L). The solution was transparent.

(molar ratio of the materials: a-BP:TPE-R:MAD=6:7:2)

### Synthesis Example 13

### Solution M

In a separable flask were placed 320 g of NMP, 53.4365 g of TPE-R and 26.5635 g of a-BP. Then, the mixture was stirred in nitrogen gas atmosphere at 50° C. for 1 hour, and then heated to 160° C. and stirred at 160° C. for 3 hours, to obtain a solution of an imide oligomer in NMP (Solution L). The solution was transparent.

(molar ratio of the materials: a-BP:TPE-R=2:3)

### Synthesis Example 14

### Solution N

In a separable flask were placed 320 g of NMP, 46.8319 g of TPE-R, 17.4603 g of a-BP and 16.0220 g of MAD. Then, the mixture was stirred in nitrogen gas atmosphere at 50° C. for 1 hour, and then heated to 160° C. and stirred at 160° C. for 3 hours, to obtain a solution of a terminal-modified imide oligomer in NMP (Solution M). The solution was transparent.

(molar ratio of the materials: a-BP:TPE-R:MAD=1:2:2)

### Synthesis Example 15

### Solution O

In a separable flask were placed 320 g of DMAc, 47.8808 g of TPE-R and 32.7616 g of MAD. Then, the mixture was stirred in nitrogen gas atmosphere at 50° C. for 1 hour, and then heated to 160° C. and stirred at 160° C. for 3 hours, to obtain a solution of bismaleimide in DMAc (Solution N). The solution was transparent.

(molar ratio of the materials: TPE-R:MAD=1:2)

### Synthesis Example 16

### Solution P

A solution of bismaleimide in NMP (Solution 0) was obtained in the same way as in Synthesis Example 14, except that NMP was used as a solvent.

(molar ratio of the materials: TPE-R:MAD=1:2)

### Synthesis Example 17

### Solution Q

In a separable flask were placed 320 g of NMP and 39.8732 g of TPE-R, and TPE-R was dissolved in NMP. Then, 39.9262 g of a-BP was stepwise added to the solution, and the mixture was stirred in nitrogen gas atmosphere at 50° C. for 1 hour, to obtain a polyamic acid solution (Solution P).

### Synthesis Example 18

### Solution R

In a separable flask were placed 320 g of DMAc and 8.0559 g of APB, and APB was dissolved in DMAc. Then, 38.1065 g of BTDA was stepwise added to the solution, and the mixture was stirred in nitrogen gas atmosphere at 50° C. for 1 hour, to obtain a polyamic acid solution (Solution Q).

### Synthesis Example 19

### Solution S

A polyamic acid solution (Solution R) was obtained in the same way as in Synthesis Example 16, except that DMAc was used as a solvent.

### Synthesis Example 20

### Solution T

In a separable flask were placed 320 g of NMP, 23.4031 g of PPD, 42.4491 g of a-BP and 14.4307 g of MAD. Then, the mixture was stirred in nitrogen gas atmosphere at 50° C. for 1 hour, to obtain a solution of a terminal-modified amic acid oligomer in NMP (Solution 5). The solution was transparent.

(molar ratio of the materials: a-BP:PPD:MAD=2:3:2)

### Synthesis Example 21

### Solution U

In a separable flask were placed 320 g of NMP, 23.4031 g of PPD, 42.4491 g of s-BP and 14.4307 g of MAD. Then, the mixture was stirred in nitrogen gas atmosphere at 50° C. for 1 hour, to obtain a solution of a terminal-modified amic acid oligomer in NMP (Solution T). The solution was transparent.

(molar ratio of the materials: s-BP:PPD:MAD=2:3:2)

### Synthesis Example 22

### Solution V

In a separable flask were placed 320 g of NMP, 27.1209 g of PPD, 36.4839 g of PMDA and 16.3953 g of MAD. Then, the mixture was stirred in nitrogen gas atmosphere at 50° C. for 1 hour, to obtain a solution of a terminal-modified amic acid oligomer in NMP (Solution U). The solution was transparent.

(molar ratio of the materials: PMDA:PPD:MAD=2:3:2)

### Synthesis Example 23

### Solution W

In a separable flask were placed 320 g of NMP, 22.2778 g of PPD, 44.2548 g of BTDA and 13.7368 g of MAD. Then, the mixture was stirred in nitrogen gas atmosphere at 50° C. for 1 hour, to obtain a solution of a terminal-modified amic acid oligomer in NMP (Solution V). The solution was transparent.

(molar ratio of the materials: BTDA:PPD:MAD=2:3:2)

### Production Example 1

### Heat Resistant Polyimide Film A

3,3′,4,4′-biphenyltetracarboxylic dianhydride and p-phenylenediamine of an equimolar amount were polymerized in N,N-dimethylacetamide, to obtain a polyimide precursor solution (polyamic acid solution) having a concentration of 18 wt % and a solution viscosity of 1800 poise (30° C.). To the polyimide precursor solution were added 0.1 parts by weight of monostearyl phosphate triethanolamine salt and 0.1 parts by weight of colloidal silica (average particle size: 0.08 μm) based on 100 parts by weight of the polyimide precursor, and 0.05 mole of 1,2-dimethylimidazole based on 1 mole of the polyimide precursor. Then, the resulting mixture was homogeneously mixed, to obtain a polyimide (A) precursor solution composition.

The polyimide precursor solution composition thus obtained was continuously cast from a slit of a T-die with a thickness of 300 μm on a smooth metal support, to form a thin film on the support. The thin film was heated at 120° C. to 160° C. for 10 min, and then peeled off from the support, to give a self-supporting film. The self-supporting film was further dried so that the content of the volatile component was 27.5 wt %.

Subsequently, a 3% solution of silane coupling agent (Y9669, made by Nippon Unicar Company Limited) was applied on the self-supporting film. Then, the self-supporting film was dried under hot air at 120° C., and then peeled off from the support, to give a self-supporting film having the silane coupling agent thereon.

The self-supporting film thus obtained was fed into a continuous heating oven while fixing both edges of the film in the width direction, and the film was gradually heated from 140° C. to 450° C. in the oven to remove the solvent and effect imidization, thereby producing a long heat resistant polyimide film A with a thickness of 35 μm which has a surface treated with a silane coupling agent.

### Production Example 2

### Heat Resistant Polyimide Film B

3,3′,4,4′-biphenyltetracarboxylic dianhydride and p-phenylenediamine of an equimolar amount were polymerized in N,N-dimethylacetamide, to obtain a polyimide precursor solution (polyamic acid solution) having a concentration of 18 wt % and a solution viscosity of 1800 poise (30° C.). To the polyimide precursor solution were added 0.1 parts by weight of monostearyl phosphate triethanolamine salt and 0.1 parts by weight of colloidal silica (average particle size: 0.08 μm) based on 100 parts by weight of the polyimide precursor, and 0.05 mole of 1,2-dimethylimidazole based on 1 mole of the polyimide precursor. Then, the resulting mixture was homogeneously mixed, to obtain a polyimide (B) precursor solution composition.

The polyimide precursor solution composition thus obtained was continuously cast from a slit of a T-die with a thickness of 100 μm on a smooth metal support, to form a thin film on the support. The thin film was heated at 120° C. to 160° C. for 10 min, and then peeled off from the support, to give a self-supporting film. The self-supporting film was further dried so that the content of the volatile component was 27.5 wt %.

Subsequently, a 3% silane coupling agent solution was applied on the self-supporting film. The 3% silane coupling agent solution was obtained by adding a silane coupling agent (Y9669, made by Dow Corning Toray Co., Ltd.) to a 5 wt % solution of a polyamic acid consisting of 2,3,3′,4′-biphenyltetracarboxylic dianhydride and 4,4′-diaminodiphenyl ether in N,N-dimethylacetamide (DMAc). Then, the self-supporting film was dried under hot air at 120° C., and then peeled off from the support, to give a self-supporting film having the silane coupling agent thereon.

The self-supporting film thus obtained was fed into a continuous heating oven while fixing both edges of the film in the width direction, and the film was gradually heated from 140° C. to 450° C. in the oven to remove the solvent and effect imidization, thereby producing a long heat resistant polyimide film B with a thickness of 12.5 μm.

Determination of the Softening Temperature and the Curing Initiation Temperature

The solvent was removed from the obtained terminal-modified imide oligomer solution or the obtained terminal-modified imide precursor oligomer solution, and the softening temperature and the curing initiation temperature of the terminal-modified imide oligomer were determined by DSC measurement. The results are shown in Table 1.

TABLE 1

| | | | terminal- | molar ratio of the materials | | |
|---|---|---|---|---|---|---|
| | | | modifying | (dianhydride:diamine: | softening | curing initiation |
| | dianhydride | diamine | agent | terminal-modifying agent) | temperature (° C.) | temperature (° C.) |
| terminal-modified | a-BP | TPE-R | MAD | 2:3:2 | 195 | 250 |
| oligomer of Solution A | | | | | | |
| terminal-modified | a-BP | TPE-R | MAD | 2:3:2 | 195 | 250 |
| oligomer of Solution B | | | | | | |
| terminal-modified | a-BP | DDE | MAD | 2:3:2 | 200 | 295 |
| oligomer of Solution D | | | | | | |
| terminal-modified | a-BP | TPE-R | MAD | 2:3:2 | 215 | 242 |
| oligomer of Solution E | | | | | | |
| terminal-modified | PMDA | TPE-R | MAD | 2:3:2 | 203 | 234 |
| oligomer of Solution F | | | | | | |
| terminal-modified | PMDA | BAPP | MAD | 2:3:2 | 178 | 235 |
| oligomer of Solution G | | | | | | |

### Example 1

The terminal-modified imide oligomer solution A prepared in Synthesis Example 1 was applied onto a copper foil NA-VLP (thickness: 12 μm; Rz: 0.8 μm; made by MITSUI MINING & SMELTING Co., Ltd.) with a bar coater No. 5. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 200° C. and 30 kgf/cm² for 30 sec, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and neither foaming nor void was observed. Subsequently, the laminate was heated at 300° C. for 7 min in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 2

The terminal-modified imide oligomer solution A prepared in Synthesis Example 1 was applied onto the silane-treated surface of the heat resistant polyimide film A with a bar coater No. 5. Then, the polyimide film was dried at 190° C. for 5 min, and then 230° C. for 3 min, using a hot air dryer, to obtain a polyimide film having a terminal-modified oligomer layer with a thickness of 2 μm thereon.

The polyimide film thus obtained and a copper foil NA-VLP (thickness: 12 μm; Rz: 0.8 μm; made by MITSUI MINING & SMELTING Co., Ltd.) were laminated such that the terminal-modified oligomer layer of the polyimide film was in contact with the copper foil. Then, the laminate was hot-pressed at 200° C. and 30 kgf/cm² for 2 min, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and no foaming was observed. Subsequently, the laminate was heated at 300° C. for 16 hours in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 3

The terminal-modified imide oligomer solution A prepared in Synthesis Example 1 was applied onto a copper foil NA-VLP (thickness: 12 μm; Rz: 0.8 μm; made by MITSUI MINING & SMELTING Co., Ltd.) with a bar coater No. 5. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film, “Kapton 150EN” (trade name; made by Du Pont-Toray Co., Ltd.) were laminated such that the terminal-modified oligomer layer of the copper foil was in contact with the polyimide film. Then, the laminate was hot-pressed at 250° C. and 30 kgf/cm² for 5 min, using a hot pressing machine (MP-WNH manufactured by TOYO SEIKI Co., Ltd.), to obtain a laminate of a copper foil and a polyimide film. The laminate thus obtained had the good laminated portion, and no foaming was observed. Subsequently, the laminate was heated at 300° C. for 16 hours in nitrogen gas atmosphere, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 4

The terminal-modified imide oligomer solution B prepared in Synthesis Example 2 was applied onto a copper foil NA-VLP (thickness: 12 μm; Rz: 0.8 μm; made by MITSUI MINING & SMELTING Co., Ltd.) with a bar coater No. 7. Then, the copper foil was dried at 160° C. for 5 min, and then 200° C. for 3 min, using a hot air dryer, to obtain a copper foil having a terminal-modified oligomer layer with a thickness of 3 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 250° C. and 30 kgf/cm² for 5 min, using a hot pressing machine (MP-WNH manufactured by TOYO SEIKI Co., Ltd.), to obtain a laminate of a copper foil and a polyimide film. The laminate thus obtained had the good laminated portion, and neither foaming nor void was observed. Subsequently, the laminate was heated at 300° C. for 16 hours in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, tool press test, and measurements of resistance to soldering heat after 23° C.-60% RH-24 hours humidity-conditioning were carried out. The results are shown in Table 2.

### Example 5

The terminal-modified imide precursor oligomer solution C prepared in Synthesis Example 3 was applied onto a copper foil NA-VLP (thickness: 12 μm; Rz: 0.8 μm; made by MITSUI MINING & SMELTING Co., Ltd.) with a bar coater No. 5. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 250° C. and 30 kgf/cm² for 5 min, using a hot pressing machine (MP-WNH manufactured by TOYO SEIKI Co., Ltd.), to obtain a laminate of a copper foil and a polyimide film. The laminate thus obtained had the good laminated portion, and neither foaming nor void was observed. Subsequently, the laminate was heated at 300° C. for 16 hours in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 6

A laminate of a heat resistant polyimide film and a metal foil was produced in the same way as in Example 5, except that the terminal-modified imide oligomer solution D prepared in Synthesis Example 4 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 7

A laminate of a heat resistant polyimide film and a metal foil was produced in the same way as in Example 4, except that the terminal-modified imide precursor oligomer solution E prepared in Synthesis Example 5 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 8

A laminate of a heat resistant polyimide film and a metal foil was produced in the same way as in Example 4, except that the terminal-modified imide precursor oligomer solution F prepared in Synthesis Example 6 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 9

A laminate of a heat resistant polyimide film and a metal foil was produced in the same way as in Example 4, except that the terminal-modified imide precursor oligomer solution G prepared in Synthesis Example 7 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 10

A laminate of a heat resistant polyimide film and a metal foil was produced in the same way as in Example 4, except that the terminal-modified imide precursor oligomer solution H prepared in Synthesis Example 8 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 11

A laminate of a heat resistant polyimide film and a metal foil was produced in the same way as in Example 4, except that the terminal-modified imide oligomer solution I prepared in Synthesis Example 9 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 12

A laminate of a heat resistant polyimide film and a metal foil was produced in the same way as in Example 4, except that the terminal-modified imide oligomer solution J prepared in Synthesis Example 10 was used. For the laminate of a heat resistant polyimide film and a metal foil thus obtained, visual observation of the presence or absence of foaming in the interface between the copper foil and the polyimide film (laminated portion), 90° peeling test, tool press test, and measurements of resistance to soldering heat after 23° C.-60% RH-24 hours humidity-conditioning were carried out. The results are shown in Table 2.

### Example 13

A laminate of a heat resistant polyimide film and a metal foil was produced in the same way as in Example 4, except that the terminal-modified imide oligomer solution K prepared in Synthesis Example 11 was used. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 14

The terminal-modified imide oligomer solution L prepared in Synthesis Example 12 was applied onto a copper foil NA-DEF (thickness: 9 μm; Rz: 0.8 μm; made by MITSUI MINING & SMELTING Co., Ltd.) with a bar coater No. 7. Then, the copper foil was dried at 160° C. for 5 min, and then 200° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 250° C. and 30 kgf/cm² for 5 min, using a hot pressing machine (MP-WNH manufactured by TOYO SEIKI Co., Ltd.), to obtain a laminate of a copper foil and a polyimide film. The laminate thus obtained had the good laminated portion, and neither foaming nor void was observed. Subsequently, the laminate was heated at 330° C. for 20 min in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 15

The terminal-modified imide oligomer solution L prepared in Synthesis Example 12 was applied onto a copper foil NA-DEF (thickness: 9 μm; Rz: 0.8 μm; made by MITSUI MINING & SMELTING Co., Ltd.) with a bar coater No. 7. Then, the copper foil was dried at 160° C. for 5 min, and then 200° C. for 3 min, using a hot air dryer, to obtain a copper foil having a terminal-modified oligomer layer with a thickness of 2 μm thereon.

The copper foil thus obtained and the heat resistant polyimide film B were laminated such that the terminal-modified oligomer layer of the copper foil was in contact with the polyimide film B. Then, the laminate was hot-pressed at 250° C. and 30 kgf/cm² for 5 min, using a hot pressing machine (MP-WNH manufactured by TOYO SEIKI Co., Ltd.), to obtain a laminate of a copper foil and a polyimide film. The laminate thus obtained had the good laminated portion, and neither foaming nor void was observed. Subsequently, the laminate was heated at 300° C. for 20 min in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 16

The terminal-modified imide oligomer solution A prepared in Synthesis Example 1 was applied onto a copper foil NA-VLP (thickness: 12 μm; Rz: 0.8 μm; made by MITSUI MINING & SMELTING Co., Ltd.) with a bar coater No. 5. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 330° C. and 30 kgf/cm² for 5 min, using a hot pressing machine (MP-WNH manufactured by TOYO SEIKI Co., Ltd.), to produce a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 17

The terminal-modified imide oligomer solution A prepared in Synthesis Example 1 was applied onto a copper foil NA-VLP (thickness: 12 μm; Rz: 0.8 μm; made by MITSUI MINING & SMELTING Co., Ltd.) with a bar coater No. 5. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 200° C. and 30 kgf/cm² for 30 sec, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and neither foaming nor void was observed. Subsequently, the laminate was heated at 350° C. for 1 hour in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Comparative Example 1

A laminate of a polyimide film and a metal foil was produced in the same way as in Example 5, except that the imide oligomer solution M prepared in Synthesis Example 12 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 2

A laminate of a polyimide film and a metal foil was produced in the same way as in Example 5, except that the imide oligomer solution N prepared in Synthesis Example 13 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 3

A laminate of a polyimide film and a metal foil was produced in the same way as in Example 5, except that the imide oligomer solution 0 prepared in Synthesis Example 14 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 4

A laminate of a polyimide film and a metal foil was produced in the same way as in Example 5, except that the solution, which was obtained by mixing the bismaleimide solution P and the polyamic acid solution Q and comprised 10 wt % of bismaleimide based on the weight of the polyamic acid, was used. In the production of the laminate, the foaming occurred during hot pressing, and a good-quality laminate of a polyimide film and a metal foil was not obtained.

### Comparative Example 5

A laminate of a polyimide film and a metal foil was produced in the same way as in Example 5, except that the solution, which was obtained by mixing the bismaleimide solution P and the polyamic acid solution Q and comprised 30 wt % of bismaleimide based on the weight of the polyamic acid, was used. In the production of the laminate, the foaming occurred during hot pressing, and a good-quality laminate of a polyimide film and a metal foil was not obtained.

### Comparative Example 6

A laminate of a polyimide film and a metal foil was produced in the same way as in Example 4, except that the solution, which was obtained by mixing the bismaleimide solution 0 and the polyamic acid solution R and comprised 10 wt % of bismaleimide based on the weight of the polyamic acid, was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 7

A laminate of a polyimide film and a metal foil was produced in the same way as in Example 4, except that the solution, which was obtained by mixing the bismaleimide solution 0 and the polyamic acid solution R and comprised 30 wt % of bismaleimide based on the weight of the polyamic acid, was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 8

A laminate of a polyimide film and a metal foil was produced in the same way as in Example 4, except that the solution, which was obtained by mixing the bismaleimide solution 0 and the polyamic acid solution R and comprised 50 wt % of bismaleimide based on the weight of the polyamic acid, was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 9

A laminate of a polyimide film and a metal foil was produced in the same way as in Example 4, except that the heat treatment in nitrogen gas atmosphere was conducted at 200° C., which is lower than the curing initiation temperature of the terminal-modified oligomer, for 16 hours. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Reference Example 1

The terminal-modified imide oligomer solution B prepared in Synthesis Example 2 was applied onto a copper foil NA-VLP (thickness: 12 μm; Rz: 0.8 μm; made by MITSUI MINING & SMELTING Co., Ltd.) so that the thickness of the terminal-modified oligomer layer was 30 μm after drying. Then, the copper foil was dried at 160° C. for 5 min, and then 200° C. for 3 min, using a hot air dryer, to obtain a copper foil having a terminal-modified oligomer layer with a thickness of 30 μm thereon.

Cracks were observed in the terminal-modified oligomer layer of the copper foil thus obtained.

### Reference Example 2

The terminal-modified imide oligomer solution B prepared in Synthesis Example 2 was applied onto a copper foil NA-VLP (thickness: 12 μm; Rz: 0.8 μm; made by MITSUI MINING & SMELTING Co., Ltd.) so that the thickness of the terminal-modified oligomer layer was 15 μm after drying. Then, the copper foil was dried at 160° C. for 5 min, and then 200° C. for 3 min, using a hot air dryer, to obtain a copper foil having a terminal-modified oligomer layer with a thickness of 15 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 200° C. and 30 kgf/cm² for 30 sec, using a hot pressing machine (MP-WNH manufactured by TOYO SEIKI Co., Ltd.), to obtain a laminate in which the copper foil was temporarily bonded to the polyimide film. Foaming and void were observed in the laminated portion of the laminate thus obtained. Foaming and void appear to be caused by the residual solvent.

### Comparative Example 10

A laminate of a polyimide film and a metal foil was produced in the same way as in Example 5, except that the amic acid oligomer solution T prepared in Synthesis Example 19 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 11

A laminate of a polyimide film and a metal foil was produced in the same way as in Example 5, except that the amic acid oligomer solution U prepared in Synthesis Example 20 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Comparative Example 12

A laminate of a polyimide film and a metal foil was produced in the same way as in Example 5, except that the amic acid oligomer solution V prepared in Synthesis Example 21 was used. In the laminate of a polyimide film and a metal foil thus obtained, the metal foil was easily peeled from the polyimide film.

### Comparative Example 13

A laminate of a polyimide film and a metal foil was produced in the same way as in Example 5, except that the amic acid oligomer solution W prepared in Synthesis Example 22 was used. For the laminate of a polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 3.

### Example 18

N-phenyl-3-aminopropyl trimethoxy silane was added to and dissolved in the terminal-modified imide oligomer solution A prepared in Synthesis Example 1 in an amount of 3 wt % based on the solid content of the terminal-modified imide oligomer solution. The solution comprising the surfactant was applied onto the silane-treated surface of the heat resistant polyimide film A with a bar coater No. 5. Then, the polyimide film was dried at 190° C. for 5 min, and then 230° C. for 3 min, using a hot air dryer, to obtain a polyimide film having a terminal-modified oligomer layer with a thickness of 2 μm thereon.

The polyimide film thus obtained and a copper foil NA-VLP (thickness: 12 μm; Rz: 0.8 μm; made by MITSUI MINING & SMELTING Co., Ltd.) were laminated such that the terminal-modified oligomer layer of the polyimide film was in contact with the copper foil. Then, the laminate was hot-pressed at 200° C. and 30 kgf/cm² for 2 min, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and no foaming was observed. Subsequently, the laminate was heated at 300° C. for 16 hours in nitrogen gas atmosphere to react unsaturated groups of the terminal-modified oligomer by heat, thereby producing a laminate of a heat resistant polyimide film and a metal foil. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 19

A laminate of a heat resistant polyimide film and a metal foil was produced in the same way as in Example 18, except that N-phenyl-3-aminopropyl trimethoxy silane was not added, and 3-glycidoxypropyl trimethoxy silane was added to the terminal-modified imide oligomer solution A in an amount of 5 wt % based on the solid content of the terminal-modified imide oligomer solution. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

### Example 20

A laminate of a heat resistant polyimide film and a metal foil was produced in the same way as in Example 18, except that N-phenyl-3-aminopropyl trimethoxy silane was not added, and 3-methacryloxypropyl trimethoxy silane was added to the terminal-modified imide oligomer solution A in an amount of 5 wt % based on the solid content of the terminal-modified imide oligomer solution. For the laminate of a heat resistant polyimide film and a metal foil thus obtained, visual observation of the presence or absence of foaming in the interface between the copper foil and the polyimide film (laminated portion), 90° peeling test, and measurements of resistance to soldering heat after 23° C.-60% RH-24 hours humidity-conditioning were carried out. The results are shown in Table 2.

TABLE 2

| | properties of laminate | | | | | | |
|---|---|---|---|---|---|---|---|
| | evaluation | adhesive | resistance to soldering heat | | tool press test | | |
| | of laminated | strength | (° C.) | | depth of wiring buried | wiring | |
| | portion | (N/mm) | 300 | 340 | in base film (μm) | breakage | foaming |
| Example 1 | ∘ | 1.10 | ∘ | ∘ | — | — | — |
| Example 2 | ∘ | 0.98 | ∘ | ∘ | — | — | — |
| Example 3 | ∘ | 1.00 | ∘ | ∘ | — | — | — |
| Example 4 | ∘ | 1.20 | ∘ | ∘ | 2.1 | Not observed | Not observed |
| Example 5 | ∘ | 1.08 | ∘ | ∘ | — | — | — |
| Example 6 | ∘ | 0.91 | ∘ | ∘ | — | — | — |
| Example 7 | ∘ | 0.70 | ∘ | ∘ | — | — | — |
| Example 8 | ∘ | 0.90 | ∘ | ∘ | — | — | — |
| Example 9 | ∘ | 1.13 | ∘ | ∘ | — | — | — |
| Example 10 | ∘ | 1.00 | ∘ | ∘ | — | — | — |
| Example 11 | ∘ | 1.07 | ∘ | ∘ | — | — | — |
| Example 12 | ∘ | 1.02 | ∘ | ∘ | 1.8 | Not observed | Not observed |
| Example 13 | ∘ | 1.05 | ∘ | ∘ | — | — | — |
| Example 14 | ∘ | 0.86 | ∘ | — | — | — | — |
| Example 15 | ∘ | 0.86 | ∘ | — | — | — | — |
| Example 16 | ∘ | 0.95 | ∘ | ∘ | — | — | — |
| Example 17 | ∘ | 0.95 | ∘ | ∘ | — | — | — |
| Example 18 | ∘ | 1.03 | ∘ | — | — | — | — |
| Example 19 | ∘ | 1.08 | ∘ | — | — | — | — |
| Example 20 | ∘ | 0.86 | ∘ | — | — | — | — |

| | application layer (application solution) | | | | | | |
|---|---|---|---|---|---|---|---|
| | | | | terminal- | | | |
| | | dianhy- | diamine | modifying | molar ratio | | |
| | solution | dride (A) | (D) | agent (M) | (A:D:M) | solvent | |
| Example 1 | A | a-BP | TPE-R | MAD | 2:3:2 | NMP | imide |
| Example 2 | A | a-BP | TPE-R | MAD | 2:3:2 | NMP | imide |
| Example 3 | A | a-BP | TPE-R | MAD | 2:3:2 | NMP | imide |
| Example 4 | B | a-BP | TPE-R | MAD | 2:3:2 | DMAc | imide |
| Example 5 | C | a-BP | TPE-R | MAD | 2:3:2 | NMP | amic acid |
| Example 6 | D | a-BP | DDE | MAD | 2:3:2 | NMP | imide |
| Example 7 | E | s-BP | TPE-R | MAD | 2:3:2 | DMAc | amic acid |
| Example 8 | F | PMDA | TPE-R | MAD | 2:3:2 | DMAc | amic acid |
| Example 9 | G | PMDA | BAPP | MAD | 2:3:2 | DMAc | amic acid |
| Example 10 | H | a-BP | TPE-R: 5 | MAD | 2:3:2 | DMAc | amic acid |
| | | | PPD: 1 | | | | |
| Example 11 | I | a-BP | TPE-R | MAD | 2:3:2 | DMAc: 7 | imide |
| | | | | | | diglyme: 3 | |
| Example 12 | J | a-BP | TPE-R | MAD | 2:3:2 | DMAc: 1 | imide |
| | | | | | | diglyme: 1 | |
| Example 13 | K | a-BP | TPE-R | MAD | 4:5:2 | DMAc | imide |
| Example 14 | L | a-BP | TPE-R | MAD | 6:7:2 | DMAc | imide |
| Example 15 | L | a-BP | TPE-R | MAD | 6:7:2 | DMAc | imide |
| Example 16 | A | a-BP | TPE-R | MAD | 2:3:2 | NMP | imide |
| Example 17 | A | a-BP | TPE-R | MAD | 2:3:2 | NMP | imide |
| Example 18 | A | a-BP | TPE-R | MAD | 2:3:2 | NMP | imide |
| | N-phenyl-3-aminopropyl trimethoxy silane | | | | | | |
| Example 19 | A | a-BP | TPE-R | MAD | 2:3:2 | NMP | imide |
| | 3-glycidoxypropyl trimethoxy silane | | | | | | |
| Example 20 | A | a-BP | TPE-R | MAD | 2:3:2 | NMP | imide |

3-methacryloxypropyl trimethoxy silane

TABLE 3

| | properties of laminate | | | |
|---|---|---|---|---|
| | evaluation of | adhesive strength | resistance to soldering heat (° C.) | |
| | laminated portion | (N/mm) | 300 | 340 |
| Comp. Example 1 | ∘ | 0 | — | — |
| Comp. Example 2 | ∘ | 0.36 | — | — |
| Comp. Example 3 | ∘ | 0.22 | — | — |
| Comp. Example 4 | x | — | — | — |
| Comp. Example 5 | x | — | — | — |
| Comp. Example 6 | ∘ | 0.86 | x | — |
| Comp. Example 7 | ∘ | 0.85 | x | — |
| Comp. Example 8 | ∘ | 0.26 | — | — |
| Comp. Example 9 | ∘ | 0 | — | — |
| Comp. Example 10 | ∘ | 0.1 | — | — |
| Comp. Example 11 | ∘ | 0.02 | — | — |
| Comp. Example 12 | ∘ | — | — | — |
| Comp. Example 13 | x | 0.02 | — | — |

| | application layer (application solution) | | | | | | |
|---|---|---|---|---|---|---|---|
| | | | | terminal- | | | |
| | | dianhy- | diamine | modifying | molar ratio | | |
| | solution | dride (A) | (D) | agent (M) | (A:D:M) | solvent | |
| Comp. Example 1 | M | a-BP | TPE-R | — | 2:3:0 | NMP | imide |
| Comp. Example 2 | N | a-BP | TPE-R | MAD | 1:2:2 | NMP | imide |
| Comp. Example 3 | O | — | TPE-R | MAD | 0:1:2 | DMAc | maleimide |
| Comp. Example 4 | P | — | TPE-R | MAD | 0:1:2 | NMP | maleimide |
| | Q | a-BP | TPE-R | — | — | NMP | amic acid |
| Comp. Example 5 | P | — | TPE-R | MAD | 0:1:2 | NMP | maleimide |
| | Q | a-BP | TPE-R | — | — | NMP | amic acid |
| Comp. Example 6 | O | — | TPE-R | MAD | 0:1:2 | DMAc | maleimide |
| | R | BTDA | APB | — | — | DMAc | amic acid |
| Comp. Example 7 | O | — | TPE-R | MAD | 0:1:2 | DMAc | maleimide |
| | R | BTDA | APB | — | — | DMAc | amic acid |
| Comp. Example 8 | O | — | TPE-R | MAD | 0:1:2 | DMAc | maleimide |
| | R | BTDA | APB | — | — | DMAc | amic acid |
| Comp. Example 9 | B | a-BP | TPE-R | MAD | 2:3:2 | DMAc | imide |
| Comp. Example 10 | T | a-BP | PPD | MAD | 2:3:2 | NMP | amic acid |
| Comp. Example 11 | U | s-BP | PPD | MAD | 2:3:2 | NMP | amic acid |
| Comp. Example 12 | V | PMDA | PPD | MAD | 2:3:2 | NMP | amic acid |
| Comp. Example 13 | W | BTDA | PPD | MAD | 2:3:2 | NMP | amic acid |

In Examples 4, 11 and 12, application properties were examined by using different solvents, i.e. either a single solvent or a mixed solvent, for the terminal-modified oligomer solution. Application properties were improved when using a mixed solvent of DMAc and diglyme as the solvent of the terminal-modified oligomer solution, as compared to when using DMAc singly. The reason appears to be that the contact angle of the solvent is reduced.

### Example 21

A radical generator “Nofmer BC” (2,3-dimethyl-2,3-diphenylmethane; made by NOF CORPORATION) was added to and dissolved in the terminal-modified imide oligomer solution B prepared in Synthesis Example 2 in an amount of 0.5 wt % based on the solid content of the terminal-modified imide oligomer solution. The solution comprising the radical generator was applied onto a copper foil NA-VLP (thickness: 12 μm; Rz: 0.8 μm; made by MITSUI MINING & SMELTING Co., Ltd.) with a bar coater No. 7. Then, the copper foil was dried at 190° C. for 5 min, and then 230° C. for 3 min, using a hot air dryer, to obtain a copper foil having a terminal-modified oligomer layer with a thickness of 2 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 250° C. and 30 kgf/cm² for 5 min, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and neither foaming nor void was observed. Subsequently, the laminate was fed into a heating oven at 200° C., and heated at 200° C. for 5 min and then heated up to 290° C. in 10 min. Then, the laminate was taken out from the heating oven. The results of the 90° peeling test for the laminate of a heat resistant polyimide film and a metal foil thus obtained are shown in Table 4.

### Example 22

A laminate of a heat resistant polyimide film and a metal foil was produced in the same way as in Example 21, except that the radical generator was added to the terminal-modified imide oligomer solution B in an amount of 1 wt % based on the solid content of the terminal-modified imide oligomer solution. The results of the 90° peeling test for the laminate of a heat resistant polyimide film and a metal foil thus obtained are shown in Table 4.

### Example 23

A laminate of a heat resistant polyimide film and a metal foil was produced in the same way as in Example 21, except that the radical generator was added to the terminal-modified imide oligomer solution B in an amount of 3 wt % based on the solid content of the terminal-modified imide oligomer solution. The results of the 90° peeling test for the laminate of a heat resistant polyimide film and a metal foil thus obtained are shown in Table 4.

### Example 24

A laminate of a heat resistant polyimide film and a metal foil was produced in the same way as in Example 21, except that the radical generator was added to the terminal-modified imide oligomer solution B in an amount of 5 wt % based on the solid content of the terminal-modified imide oligomer solution. The results of the 90° peeling test for the laminate of a heat resistant polyimide film and a metal foil thus obtained are shown in Table 4.

### Example 25

A laminate of a heat resistant polyimide film and a metal foil was produced in the same way as in Example 21, except that the radical generator was added to the terminal-modified imide oligomer solution B in an amount of 10 wt % based on the solid content of the terminal-modified imide oligomer solution. The results of the 90° peeling test for the laminate of a heat resistant polyimide film and a metal foil thus obtained are shown in Table 4.

### Example 26

A radical generator “Nofmer BC” (2,3-dimethyl-2,3-diphenylmethane; made by NOF CORPORATION) was added to and dissolved in the terminal-modified imide oligomer solution J prepared in Synthesis Example 10 in an amount of 0.5 wt % based on the solid content of the terminal-modified imide oligomer solution. The solution comprising the radical generator was applied onto a copper foil NA-DEF (thickness: 9 μm; Rz: 0.8 μm; made by MITSUI MINING & SMELTING Co., Ltd.) with a gravure coater. Then, the copper foil was dried at 200° C. for 3 min, using a floating hot air dryer, to obtain a copper foil having a terminal-modified oligomer layer with a thickness of 1.5 μm thereon.

The copper foil thus obtained and the heat resistant polyimide film A were laminated such that the terminal-modified oligomer layer of the copper foil was in contact with the silane-treated surface of the polyimide film A. Then, the laminate was hot-pressed at 250° C. and 30 kgf/cm² for 5 min, using a hot pressing machine (MP-WNH manufactured by TOYO SEIKI Co., Ltd.), to obtain a laminate in which the copper foil was temporarily bonded to the polyimide film. The laminate thus obtained had the good laminated portion, and neither foaming nor void was observed. Subsequently, the laminate was fed into a heating oven at 200° C., and heated at 200° C. for 5 min and then heated up to 320° C. in 9 min. Then, the laminate was taken out from the heating oven. The results of the 90° peeling test for the laminate of a heat resistant polyimide film and a metal foil thus obtained are shown in Table 4.

### Reference Example 3

A laminate of a heat resistant polyimide film and a metal foil was produced in the same way as in Example 21, except that the radical generator was not added to the terminal-modified imide oligomer solution B. The results of the 90° peeling test for the laminate of a heat resistant polyimide film and a metal foil thus obtained are shown in Table 4.

### Reference Example 4

A laminate of a heat resistant polyimide film and a metal foil was produced in the same way as in Example 26, except that the radical generator was not added to the terminal-modified imide oligomer solution J. The results of the 90° peeling test for the laminate of a heat resistant polyimide film and a metal foil thus obtained are shown in Table 4.

TABLE 4

| | amount of | 90° peel strength |
|---|---|---|
| | radical generator | (N/mm) |
| Example 21 | 0.50 wt % | 0.6 |
| Example 22 | 1 wt % | 0.7 |
| Example 23 | 3 wt % | 0.6 |
| Example 24 | 5 wt % | 0.7 |
| Example 25 | 10 wt % | 0.8 |
| Example 26 | 0.50 wt % | 0.8 |
| Reference Example 3 | 0 wt % | 0.1 |
| Reference Example 4 | 0 wt % | 0.1 |

### Reference Example 5

A laminate of a heat resistant polyimide film and a metal foil was produced in the same way as in Reference Example 3, except that the laminate in which the copper foil was temporarily bonded to the polyimide film was heated up to 290° C. in 10 min, and then heated up to 307° C. in 7 min and kept at 307° C. for 3 min, and then the laminate was taken out from the heating oven. The 90° peel strength of the laminate of a heat resistant polyimide film and a metal foil thus obtained was 0.7 N/mm.

In Examples 21 to 26, the radical generator was added to the terminal-modified imide oligomer solution, and therefore the high adhesive strength was achieved by heat treatment at a lower temperature for a shorter time, as compared to when no radical generator was added.

1. A laminate having a metal foil on one side or both sides of a heat resistant film, wherein
the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group;
the diamine component comprises a diamine represented by the general formula (1):
H₂N—Y—NH₂ (1)
wherein
Y represents a divalent group selected from the groups listed as the following formula (2): 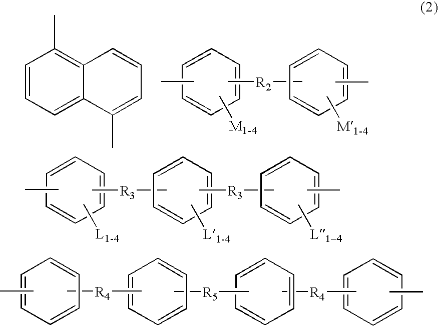
wherein
R₂, R₃, R₄ and R₅ independently represent a single bond, or a divalent group selected from the group consisting of —O—, —S—, —CO—, —SO₂—, —CH₂—, —C(CH₃)₂—, and —C(CF₃)₂—,
M₁—M₄, M′₁-M′₄, L₁-L₄, L′ᵢ-L′₄ and L″₁— L″₄ independently represent —H, —F, —Cl, —Br, —I, —CN, —OCH₃, —OH, —COOH, —CH₃, —C₂H₅, or —CF₃,
R₂, R₃, R₄ and R₅ may be the same as, or different from each other, and
M₁-M₄, M′₁— M′₄, L₁-L₄, L′₁— L′₄ and L″₁— L″₄ may be the same as, or different from each other,
as a main component;
the tetracarboxylic dianhydride component comprises a tetracarboxylic dianhydride represented by the general formula (3): 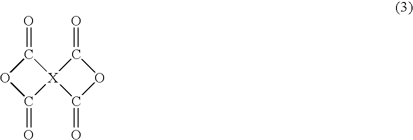
wherein
X represents a tetravalent group selected from the groups listed as the following formula (4): 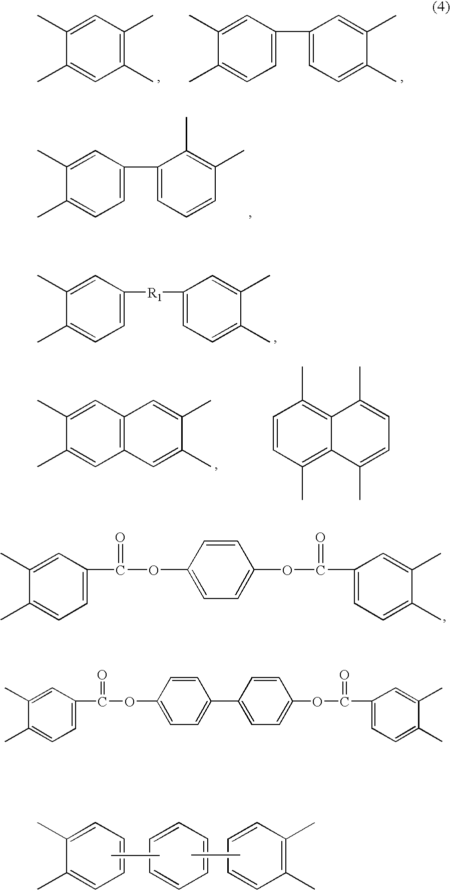
wherein
R₁ represents a divalent group selected from the groups listed as the following formula (5):
as a main component; and 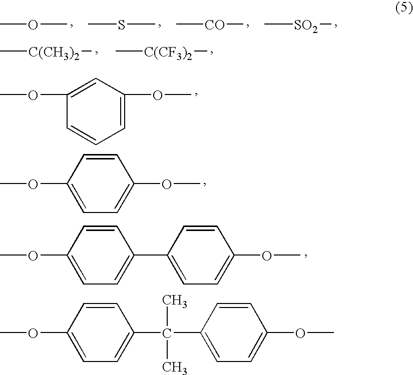
the carboxylic acid compound is represented by the general formula (6): 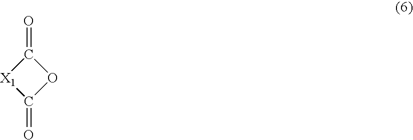
wherein
X₁ represents a divalent group selected from the groups listed as the following formula (7): 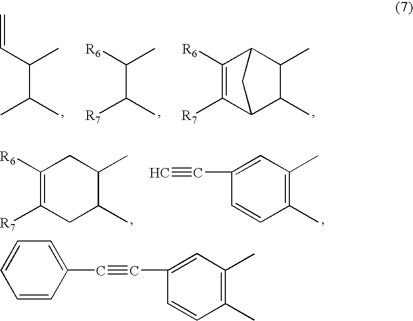
wherein
R₆ and R₇ independently represent —H, —F, —CH₃, —C₂H₅, —CF₃, or -phenyl, and
R₆ and R₇ may be the same as, or different from each other.

2. The laminate of a heat resistant film and a metal foil as claimed in claim 1, wherein
the diamine component is a diamine represented by the general formula (1′):
H₂N—Y—NH₂ (1′)
wherein
Y represents a divalent group selected from the groups listed as the following formula (2′): 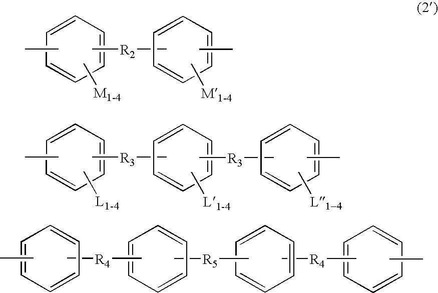
wherein
R₂ represents a single bond, or a divalent group selected from the group consisting of —O—, —S—, —CH₂—, and —C(CH₃)₂—,
R₃ and R₄ independently represent —O—, or —S—,
R₅ represents a single bond, or a divalent group selected from the group consisting of —O—, —CH₂—, and —C(CH₃)₂—,
M₁-N₄, N4′-M′₄, L₁-L₄, L′₁— L′₄ and L″₁— L″₄ independently represent —H, or —CH₃,
R₂, R₃, R₄ and R₅ may be the same as, or different from each other, and
M₁-M₄, M′₁— M′₄, L₁-L₄, -L′₄ and L″₁— L″₄ may be the same as, or different from each other;
the tetracarboxylic dianhydride component is a tetracarboxylic dianhydride represented by the general formula (3′): 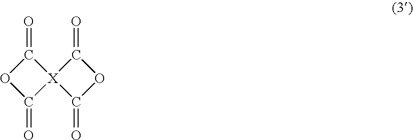
wherein
X represents a tetravalent group selected from the groups listed as the following formula (4′): 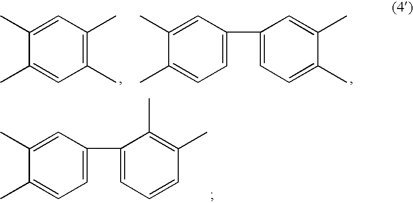
and
the carboxylic acid compound having an unsaturated group is a compound represented by the general formula (6′): 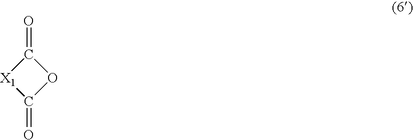
wherein
X₁ represents a divalent group selected from the groups listed as the following formula (7′): 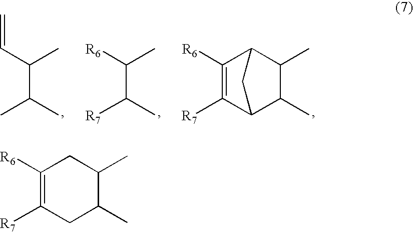
wherein
R₆ and R₇ independently represent —H, —F, —CH₃, —C₂H₅, —CF₃, or -phenyl, and
R₆ and R₇ may be the same as, or different from each other.

3. The laminate of a heat resistant film and a metal foil as claimed in claim 1, wherein the cured layer of the terminal-modified oligomer is a cured layer of a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 3).

4. The laminate of a heat resistant film and a metal foil as claimed in claim 1, wherein the cured layer of the terminal-modified oligomer is a cured layer of a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 2).

5. The laminate of a heat resistant film and a metal foil as claimed in claim 1, wherein the terminal-modified oligomer is
1) a terminal-modified oligomer obtained by reacting a oligomer which is obtained by reacting a tetracarboxylic dianhydride component and a diamine component with a carboxylic acid compound having an unsaturated group which is represented by the general formula (6); or
2) a terminal-modified oligomer obtained by reacting simultaneously a tetracarboxylic dianhydride component, a diamine component, and a carboxylic acid compound having an unsaturated group which is represented by the general formula (6).

6. The laminate of a heat resistant film and a metal foil as claimed in claim 1, wherein the carboxylic acid compound having an unsaturated group which is represented by the general formula (6) is maleic anhydride.

7. The laminate of a heat resistant film and a metal foil as claimed in claim 1, wherein the cured layer of the terminal-modified oligomer is obtained by heating a terminal-modified oligomer to a temperature lower by 10° C. than the curing initiation temperature of the terminal-modified oligomer, or higher.

8. The laminate of a heat resistant film and a metal foil as claimed in claim 1, wherein the cured layer of the terminal-modified oligomer has a thickness of 0.5 μm to 12 μm.

9. The laminate of a heat resistant film and a metal foil as claimed in claim 1, wherein the heat resistant film is a heat resistant polyimide film.

10. The laminate of a heat resistant film and a metal foil as claimed in claim 1, wherein the cured layer of the terminal-modified oligomer is obtained by heating a terminal-modified oligomer composition which comprises a terminal-modified oligomer and 0.1 wt % to 10 wt % of a radical generator based on the solid content of the terminal-modified oligomer to react it.

11. A process for producing a laminate having a metal foil on one side or both sides of a heat resistant film wherein the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group which is represented by the above general formula (6); comprising:
(1) a step of forming a terminal-modified oligomer layer on a heat resistant film and/or a metal foil by
applying a solution of a terminal-modified oligomer in an organic solvent to one side or both sides of a heat resistant film or one side of a metal foil;
removing the organic solvent contained in the solution applied to the heat resistant film or the metal foil; and
heating the heat resistant film or the metal foil having the terminal-modified oligomer thereon to effect imidization, if the terminal-modified oligomer comprises a polyimide precursor;
(a1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon; and
pressing the laminate at a temperature lower by 10° C. than the softening temperature of the terminal-modified oligomer, or higher; and
(a2) a step of heating the pressed laminate of the heat resistant film, the terminal-modified oligomer layer and the metal foil up to a temperature lower by 10° C. than the curing initiation temperature of the terminal-modified oligomer, or higher to cure the terminal-modified oligomer.

12. A process for producing a laminate having a metal foil on one side or both sides of a heat resistant film wherein the metal foil is laminated on the heat resistant film via a cured layer of a terminal-modified oligomer obtained by reacting simultaneously or successively a tetracarboxylic dianhydride component and a diamine component in a molar ratio of n:(n+1) (n is a number of 2 to 6) and a carboxylic acid compound having an unsaturated group which is represented by the above general formula (6); comprising:
(1) a step of forming a terminal-modified oligomer layer on a heat resistant film and/or a metal foil by
applying a solution of a terminal-modified oligomer in an organic solvent to one side or both sides of a heat resistant film or one side of a metal foil;
removing the organic solvent contained in the solution applied to the heat resistant film or the metal foil; and
heating the heat resistant film or the metal foil having the terminal-modified oligomer thereon to effect imidization, if the terminal-modified oligomer comprises a polyimide precursor; and
(b1) a step of forming a laminate of a heat resistant film, a terminal-modified oligomer layer and a metal foil which are laminated in this order, using the heat resistant film having the terminal-modified oligomer layer thereon and/or the metal foil having the terminal-modified oligomer layer thereon; and
heating and pressing the laminate at a temperature lower by 10° C. than the curing initiation temperature of the terminal-modified oligomer, or higher to cure the terminal-modified oligomer.

13. The process for producing a laminate of a heat resistant film and a metal foil as claimed in claim 11, wherein the solution of the terminal-modified oligomer in the organic solvent contains 0.1 wt % to 10 wt % of a radical generator capable of generating oxygen radicals or carbon radicals based on the solid content of the terminal-modified oligomer.

14. The process for producing a laminate of a heat resistant film and a metal foil as claimed in claim 11, wherein the terminal-modified oligomer is a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 3).

15. The process for producing a laminate of a heat resistant film and a metal foil as claimed in claim 11, wherein the terminal-modified oligomer is a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 2).

16. The process for producing a laminate of a heat resistant film and a metal foil as claimed in claim 12, wherein the solution of the terminal-modified oligomer in the organic solvent contains 0.1 wt % to 10 wt % of a radical generator capable of generating oxygen radicals or carbon radicals based on the solid content of the terminal-modified oligomer.

17. The process for producing a laminate of a heat resistant film and a metal foil as claimed in claim 12, wherein the terminal-modified oligomer is a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 3).

18. The process for producing a laminate of a heat resistant film and a metal foil as claimed in claim 12, wherein the terminal-modified oligomer is a terminal-modified oligomer obtained by reacting simultaneously or successively a tetracarboxylic dianhydride component, a diamine component, and a carboxylic acid compound having an unsaturated group which is represented by the general formula (6) in a molar ratio of n:(n+1):m (n is a number of 2 to 6, and m is a number of 1 to 2).
